(19) United States
(12) Patent Application Publication
(10) Pub. No.: US 2025/0330392 A1
(43) Pub. Date: Oct. 23, 2025

(54) MODEL INFORMATION TRANSMISSION METHOD AND APPARATUS, AND DEVICE

(71) Applicant: VIVO MOBILE COMMUNICATION CO., LTD., Guangdong (CN)

(72) Inventors: Tong ZHOU, Guangdong (CN); Hongping ZHANG, Guangdong (CN); Peng SUN, Guangdong (CN); Rakesh TAMRAKAR, Guangdong (CN); Xiang PAN, Guangdong (CN)

(73) Assignee: VIVO MOBILE COMMUNICATION CO., LTD., Guangdong (CN)

(21) Appl. No.: 19/253,065

(22) Filed: Jun. 27, 2025

Related U.S. Application Data
(63) Continuation of application No. PCT/CN2023/140871, filed on Dec. 22, 2023.

(30) Foreign Application Priority Data
Dec. 29, 2022 (CN) 202211726738.7

(51) Int. Cl. H04L 41/16; H04W 8/22; H04W 24/08

(52) U.S. Cl. CPC H04L 41/16; H04W 8/22; H04W 24/08

(57) ABSTRACT

This application discloses a model information transmission method and apparatus, and a device. The model information transmission method in embodiments of this application includes: sending, by a first device, first information to a second device, where the first information includes at least one of the following: AI model description information, where the AI model description information is used to describe an AI model corresponding to the first device; and first capability information associated with an AI model, where the first capability information is used to select an AI model.

### CROSS-REFERENCE TO RELATED APPLICATIONS

This application is a continuation application of PCT International Application No. PCT/CN2023/140871 filed on Dec. 22, 2023, which claims priority to Chinese Patent Application No. 202211726738.7, filed on Dec. 29, 2022, which is incorporated herein by reference in its entirety.

### TECHNICAL FIELD

This application pertains to the field of communication technologies, and specifically relates to a model information transmission method and apparatus, and a device.

### BACKGROUND

Some communication systems introduce an artificial intelligence (AI) model to perform a communication-related operation, for example, at a physical layer, there is AI model-based channel state information (CSI) feedback compression, AI model-based channel estimation, AI model-based beam management, AI model-based positioning, and the like. However, when the AI model is used to perform the communication-related operation, a plurality of devices are often involved. Currently, AI model-related information between devices is unknown to each other, which causes an inconsistent understanding of the AI model-related information between the devices, and affects communication performance between the devices.

### SUMMARY

According to a first aspect, a model information transmission method is provided, including:
sending, by a first device, first information to a second device, where the first information includes at least one of the following:
artificial intelligence AI model description information, where the AI model description information is used to describe an AI model corresponding to the first device; and
first capability information associated with an AI model, where the first capability information is used to select an AI model.

According to a second aspect, a model information transmission method is provided, including:
receiving, by a second device, first information sent by a first device, where the first information includes at least one of the following:
artificial intelligence AI model description information, where the AI model description information is used to describe an AI model corresponding to the first device; and
first capability information associated with an AI model, where the first capability information is used to select an AI model.

According to a third aspect, a model information transmission apparatus is provided, applied to a first device, where the model information transmission apparatus includes:
a sending module, configured to send first information to a second device, where the first information includes at least one of the following:
artificial intelligence AI model description information, where the AI model description information is used to describe an AI model corresponding to the first device; and
first capability information associated with an AI model, where the first capability information is used to select an AI model.

According to a fourth aspect, a model information transmission apparatus is provided, applied to a second device, where the model information transmission apparatus includes:
a receiving module, configured to receive first information sent by a first device, where the first information includes at least one of the following:
artificial intelligence AI model description information, where the AI model description information is used to describe an AI model corresponding to the first device; and
first capability information associated with an AI model, where the first capability information is used to select an AI model.

According to a fifth aspect, a communication device is provided, where the communication device is a first device, the communication device includes a processor and a memory, the memory stores a program or instructions capable of running on the processor, and the program or the instructions are executed by the processor to implement the steps of the model information transmission method on the first device side provided in the embodiments of this application.

According to a sixth aspect, a communication device is provided, where the communication device is a first device, and includes a processor and a communication interface, and the communication interface is configured to send first information to a second device, where the first information includes at least one of the following: artificial intelligence AI model description information, where the AI model description information is used to describe an AI model corresponding to the first device; and first capability information associated with an AI model, where the first capability information is used to select an AI model.

According to a seventh aspect, a communication device is provided, where the communication device is a second device, the communication device includes a processor and a memory, the memory stores a program or instructions capable of running on the processor, and the program or the instructions are executed by the processor to implement the steps of the model information transmission method on the second device side provided in the embodiments of this application.

According to an eighth aspect, a communication device is provided, where the communication device is a second device, and includes a processor and a communication interface, and the communication interface is configured to receive first information sent by a first device, where the first information includes at least one of the following: artificial intelligence AI model description information, where the AI model description information is used to describe an AI model corresponding to the first device; and first capability information associated with an AI model, where the first capability information is used to select an AI model.

According to a ninth aspect, a model information transmission system is provided, including a first device and a second device, where the first device may be configured to perform the steps of the model information transmission method on the first device side provided in the embodiments of this application, and the second device may be configured to perform the steps of the model information transmission method on the second device side provided in the embodiments of this application.

According to a tenth aspect, a readable storage medium is provided, where the readable storage medium stores a program or instructions, and the program or the instructions are executed by a processor to implement the steps of the model information transmission method on the first device side provided in the embodiments of this application, or to implement the steps of the model information transmission method on the second device side provided in the embodiments of this application.

According to an eleventh aspect, a chip is provided, where the chip includes a processor and a communication interface, the communication interface is coupled to the processor, and the processor is configured to run a program or instructions to implement the model information transmission method on the first device side provided in the embodiments of this application, or implement the model information transmission method on the second device side provided in the embodiments of this application.

According to a twelfth aspect, a computer program/program product is provided, where the computer program/program product is stored in a storage medium, and the computer program/program product is executed by at least one processor to implement the steps of the model information transmission method on the first device side provided in the embodiments of this application, or the computer program/program product is executed by at least one processor to implement the steps of the model information transmission method on the second device side provided in the embodiments of this application.

### BRIEF DESCRIPTION OF DRAWINGS

FIG. 1 is a block diagram of a wireless communication system applicable to an embodiment of this application;

FIG. 2 is a flowchart of a model information transmission method according to an embodiment of this application;

FIG. 3 is a flowchart of another model information transmission method according to an embodiment of this application;

FIG. 4 is a schematic diagram of a model information transmission method according to an embodiment of this application;

FIG. 5 is a schematic diagram of another model information transmission method according to an embodiment of this application;

FIG. 6 is a schematic diagram of another model information transmission method according to an embodiment of this application;

FIG. 7 is a schematic diagram of another model information transmission method according to an embodiment of this application;

FIG. 8 is a schematic diagram of another model information transmission method according to an embodiment of this application;

FIG. 9 is a schematic diagram of another model information transmission method according to an embodiment of this application;

FIG. 10 is a schematic diagram of another model information transmission method according to an embodiment of this application;

FIG. 11 is a schematic diagram of another model information transmission method according to an embodiment of this application;

FIG. 12 is a schematic diagram of another model information transmission method according to an embodiment of this application;

FIG. 13 is a structural diagram of a model information transmission apparatus according to an embodiment of this application;

FIG. 14 is a structural diagram of another model information transmission apparatus according to an embodiment of this application;

FIG. 15 is a structural diagram of a communication device according to an embodiment of this application;

FIG. 16 is a structural diagram of another communication device according to an embodiment of this application; and

FIG. 17 is a structural diagram of another communication device according to an embodiment of this application.

### DESCRIPTION OF EMBODIMENTS

The following clearly describes technical solutions in embodiments of this application with reference to accompanying drawings in the embodiments of this application. Clearly, the described embodiments are merely some rather than all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specified order or sequence. It should be understood that, terms used in this way may be interchangeable under appropriate circumstances, so that the embodiments of this application can be implemented in an order other than that illustrated or described herein. Moreover, the terms “first” and “second” typically distinguish between objects of one category rather than limiting a quantity of objects. For example, a first object may be one object or a plurality of objects. In addition, in the specification and claims, “and/or” represents at least one of connected objects, and the character “/” generally represents an “or” relationship between associated objects.

The term “indication” in the specification and claims of this application may be an explicit indication, or may be an implicit indication. The explicit indication may be understood as: A sender explicitly notifies, in a sent indication, a receiver of an operation that needs to be performed or a requested result. The implicit indication may be understood as: The receiver performs determining based on the indication sent by the sender, and determines, based on a determining result, the operation that needs to be performed or the requested result.

It should be noted that, a technology described in embodiments of this application is not limited to a long term evolution (LTE)/LTE-advanced (LTE-A) system, and may be further applied to other wireless communication systems, such as a code division multiple access (CDMA) system, a time division multiple access (TDMA) system, a frequency division multiple access (FDMA) system, an orthogonal frequency division multiple access (OFDMA) system, a single-carrier frequency division multiple access (SC-FDMA) system, and another system. The terms “system” and “network” are often used interchangeably in the embodiments of this application. A technology described may be used for the systems and radio technologies described above, as well as other systems and radio technologies. The following describes a new radio (NR) system for illustrative purposes, and NR terms are used in most of the following descriptions. However, these technologies are also applicable to applications such as a 6th generation (6G) communication system other than NR system applications.

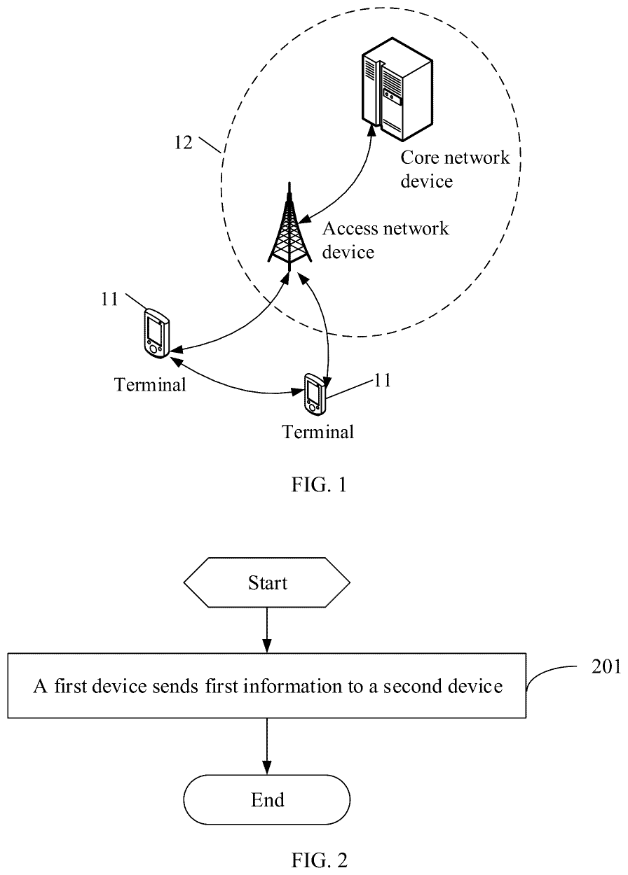

FIG. 1 is a block diagram of a wireless communication system applicable to an embodiment of this application. The wireless communication system includes a terminal 11 and a network-side device 12. The terminal 11 may be a mobile phone, a tablet personal computer, a laptop computer or referred to as a notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device, vehicle user equipment (VUE), pedestrian user equipment (PUE), a smart home (a home device with a wireless communication function, such as a refrigerator, a television, a laundry machine, or a furniture), a gaming console, a personal computer (PC), a teller machine, a self-service machine, or another terminal-side device. The wearable device includes: a smart watch, a smart band, a smart headset, smart glasses, smart jewelry (a smart bracelet, a smart wristlet, a smart ring, a smart necklace, a smart anklet, a smart leglet, and the like), a smart wristband, smart clothing, and the like. It should be noted that a specific type of the terminal 11 is not limited in this embodiment of this application. The network-side device 12 may include an access network device or a core network device. The access network device may also be referred to as a wireless access network device, a radio access network (RAN), a radio access network function, or a radio access network unit. The access network device may include a base station, a wireless local area network (WLAN) access point, a WiFi node, or the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a transmitting receiving point (TRP), or another appropriate term in the field. Provided that same technical effects are achieved, the base station is not limited to a specific technical term. It should be noted that in the embodiments of this application, only a base station in an NR system is used as an example for description, and a specific type of the base station is not limited. The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function (PCRF) unit, an edge application server discovery function (EASDF), unified data management (UDM), a unified data repository (UDR), a home subscriber server (HSS), a centralized network configuration (CNC), a network repository function (NRF), a network exposure function (NEF), a local NEF (Local NEF or L-NEF), a binding support function (BSF), an application function (AF), and the like. It should be noted that in the embodiments of this application, only a core network device in the NR system is used as an example for description, and a specific type of the core network device is not limited.

In some embodiments, at a physical layer, a communication device may perform channel state information (CSI) feedback compression based on an AI model, may perform beam management based on an AI model, and may perform positioning based on an AI model, and more use cases combined with the AI model appear in a mobile communication system.

In some embodiments, AI model registration may include the following cases:
Case 1: After an AI model provider produces a model, the model is registered with a network, and then the model is downloaded by a terminal.
Case 2: An AI model has been deployed on a terminal, and a network needs to manage a lifecycle of the AI model, for example, monitor model performance, and control model activation and deactivation.
Case 3: An AI model is deployed on a terminal and has been activated, and a network uses an output result of the model.
Case 4: An AI model is deployed on a terminal, and a network needs to collect data to train and update the deployed model.

With reference to the accompanying drawings, a model information transmission method and apparatus and a device provided in the embodiments of this application are described in detail below by using some embodiments and application scenarios thereof.

Referring to FIG. 2, FIG. 2 is a flowchart of a model information transmission method according to an embodiment of this application. As shown in FIG. 2, the method includes the following step:

Step 201: A first device sends first information to a second device, where the first information includes at least one of the following:
AI model description information, where the AI model description information is used to describe an AI model corresponding to the first device; and
first capability information associated with an AI model, where the first capability information is used to select an AI model.

The first device may be a terminal, and the second device may be an access network device or a core network device.

The AI model corresponding to the first device may be an AI model deployed on the first device, or an AI model that the first device request to deploy or register, or an AI model selected by the first device.

In addition, an inference result of the AI model corresponding to the first device may be used by the first device or the second device.

The AI model description information may be used to represent information about an AI model, or may be used to describe usage information of the foregoing AI model, or may represent functionality information of the foregoing AI model.

The first capability information may be used to represent capability information of the first device for the AI model.

In this embodiment of this application, the foregoing steps may be used to send the first information, so that a consistent understanding of the AI model corresponding to the first device can be more easily reached between the first device and the second device, thereby helping improve communication performance between the first device and the second device.

In some implementations, the first information may be applied to a model registration process. With the first information, information for different registration purposes may be defined in the model registration process, so that a network can use a model output to provide lifecycle management for a model deployment device. Then, the first capability information is reported or registration information is broadcast, so that the network or the terminal can select a model that matches a capability of the terminal. For example:

In a case that after an AI model provider produces a model, the model is registered with the network, and then the model is downloaded by the terminal, the first information may enable the network to select a matching model for the first device.

In a case that an AI model has been deployed to a user equipment, and the network needs to manage a lifecycle of the AI model, the first information may enable the network to perform model lifecycle management such as model activation and model monitoring.

In a case that an AI model is deployed on the terminal and has been activated, and the network uses an output result of the model, the first information may enable the network to determine validity of the result and determine a physical meaning corresponding to the output of the AI model.

In an optional implementation, the AI model description information includes at least one of the following:
an AI model functionality an AI model usage condition, and AI model Identifier information.

The AI model functionality is used to represent a specific functionality of the AI model. The AI model usage condition may represent a usage condition of inference of the AI model, or may represent a usage condition of an inference result of the AI model, or may represent a configuration condition or a scenario condition of the AI model.

In this implementation, at least one of the AI model functionality, the AI model usage condition, and the AI model identifier information may enable a consistent understanding of a functionality, a usage condition, and an identifier of the AI model correspond to the first device to be reached between the first device and the second device, thereby facilitating communication performance between the first device and the second device.

Optionally, the AI model usage condition includes at least one of the following:
an AI model configuration condition, an AI model scenario condition, and an AI model data condition.

The AI model configuration condition may mean that a required configuration matches an actual configuration. For example, if the required configuration is eight transmit beams of a base station, and an actual configuration of the base station is eight transmit beams, the configuration is valid. Otherwise, the configuration is invalid. In a case that the configuration is valid, the AI model is used. In a case that the configuration is invalid, the AI model is not used.

In the AI model configuration condition, a configuration of the second device may be explicitly indicated, or may be implicitly indicated by using a user group identifier or a configuration identifier. The plaintext configuration of the second device may include at least one of the following:
antenna configuration information of the second device;
beam configuration information of the second device;
beam quantity information of the second device;
height information of the second device; and
inter-site distance information of the second device.

In this way, only in the foregoing configuration case, the second device can use the inference result of the AI model.

In addition, the AI model configuration condition may include a configuration of the first device, and the configuration of the first device may be explicitly indicated, or may be implicitly indicated by using a user group identifier or a configuration identifier. The plaintext configuration of the first device may include at least one of the following:
a terminal antenna configuration;
a terminal beam configuration;
a quantity of terminal beams; and
a quantity of terminal antenna panels.

In this way, only in the foregoing configuration case, the first device can use the AI model.

The AI model scenario condition may mean that a required scenario matches an actual scenario. If the required scenario matches the actual scenario, the AI model is used. Otherwise, the AI model is not used.

In the AI model scenario condition, a scenario of the second device may include at least one of the following:
line-of-sight scenario information;
non-line-of-sight scenario information;
outdoor scenario information;
indoor scenario information;
user-intensive scenario information;
user-sparse scenario information; and
scenario information of different rainfall volumes.

In this way, only in the foregoing scenario, the second device can use the inference result of the AI model.

In some implementations, the AI model data condition may be an AI model data collection condition, for example, may indicate an inference data collection condition corresponding to the AI model, or may indicate an inference data configuration condition of the AI model, or may indicate a data processing condition of the AI model.

In some implementations, the AI model data condition may be a data condition used during training, inference, or output of the AI model. For example, the AI model data condition may be an AI model data collection condition, and the data collection condition may be a collection condition related to inference input data.

In some implementations, the AI model data condition may include at least one of the following:
network-side additional information, where the network-side additional information is used to indicate the second device to provide additional information for the AI model of the first device; and
a network-side additional configuration, where the network-side additional configuration is used to indicate the second device to perform related configuration for the AI model of the first device;
a network data processing indicator, where the network data processing indicator is used to indicate at least one of the following: a data processing manner for input data of the AI model of the first device and a data processing manner for output data of the AI model of the first device; and
split inference information, where the split inference information is information for performing model split inference by the first device and the second device.

The AI model data condition may be an inference data collection condition, and may be specifically a condition that needs to be matched or met when inference data is collected. The monitoring data collection condition may be a condition that needs to be matched or met when monitoring data is collected.

The network-side additional information may indicate the second device to provide some information as a partial input of the AI model. For example, the network-side additional information may include at least one of the following:
transmit beam information of the second device, for example, a beam direction, a beam codebook, and a beam width;
antenna architecture information of the second device, for example, a panel orientation, an antenna quantity, and an antenna spacing; and
position information of the second device.

The network-side additional configuration may provide a corresponding configuration for the AI model. For example, when the first device performs inference, the second device performs corresponding special configuration to assist the first device in inference. For example, when the first device performs receive beam prediction based on the AI model, a transmit beam additional configuration of the second device is fixed, to assist receive beams of the first device in performing receiving based on a same transmit beam. Therefore, receive beam prediction can be better performed. When the first device performs channel prediction based on the AI model, the second device adjusts to a quantity, of channel state information reference signal (CSI-RS) resources, that matches the model, to enable channel prediction on the second device side.

The network data processing indicator may be a preprocessing indicator or a postprocessing indicator. For example, preprocessing is performed on input data of the AI model of the first device, and postprocessing is performed on output data of the AI model of the first device.

In some implementations, the network data processing indicator may also be indicated by a user group identifier, and a same user group uses a same data processing indicator.

In some implementations, the network data processing indicator may be used to determine a specified data processing manner, and the data processing manner may include at least one of the following:
data bias processing;
data scaling processing;
function transformation processing;
multi-dimensional mapping processing;
disorder processing;
one-hot encoding processing;
data normalization processing;
data regularization processing; and
data standardization processing.

The one-hot encoding processing may mean mapping data with a same physical meaning to a same one-hot code by using a one-hot encoding dictionary configuration.

The data bias processing may be applying a bias to data. For example, if an original value is 10 and a bias value of data bias processing is 100, a value obtained after data bias processing is 10−100=−90.

The data scaling processing may be scaling data. For example, if an original value is 100 and a scaling-down value of data scaling processing is 0.1, a value obtained after data scaling processing is 100*0.1=10.

The function transformation processing may be performing polynomial function transformation on data. For example, if an original value is 10 and a transform function of function transformation processing is f(x)=2x\hat{ }3+5, a value obtained after function transformation processing is 2*10\hat{ }3+5=2005.

The multi-dimensional mapping processing may be performing multi-dimensional mapping on a single piece of data. For example, if an original value is 10 and a mapping manner of multi-dimensional mapping processing is (0.1x+2, 0.5x+6), a value obtained after multi-dimensional mapping processing is (0.1*10+2, 0.5*10+6), that is, (3, 11).

The disorder processing may be performing a disorder operation on a group of data. For example, an original data group is (−70, −20, 20, 70, 22.5, 112.5, 22.5, 112.5), and a physical meaning of the original data group is shown in Table 2:

TABLE 2

| | Physical meaning in | Value in an |
|---|---|---|
| No | an original order | original order |
| 1 | Horizontal pointing angle | −70 |
| | of a measurement beam 1 | |
| 2 | Horizontal pointing angle | −20 |
| | of a measurement beam2 | |
| 3 | Horizontal pointing angle | 20 |
| | of a measurement beam3 | |
| 4 | Horizontal pointing angle | 70 |
| | of a measurement beam4 | |
| 5 | Vertical pointing angle of | 22.5 |
| | the measurement beam1 | |
| 6 | Vertical pointing angle of | 112.5 |
| | the measurement beam2 | |
| 7 | Vertical pointing angle of | 22.5 |
| | the measurement beam3 | |
| 8 | Vertical pointing angle of | 112.5 |
| | the measurement beam4 | |

A parameter of disorder processing is (4 3 1 5 6 7 8 2), that is, the first data obtained after disorder processing is the fourth data in the original data group, the second data obtained after disorder processing is the third data in the original data group, the third data obtained after disorder processing is the first data in the original data group, and so on. After a disorder operation is performed on the original data group, a data group obtained after disorder processing is (70, 20, −70, 22.5, 112.5, 22.5, 112.5, −10). A physical meaning of the data group obtained after disorder processing is shown in Table 3:

TABLE 3

| | | Value after |
|---|---|---|
| No | Physical meaning after disorder | disorder |
| 1 | Horizontal pointing angle | 70 |
| | of a measurement beam4 | |
| 2 | Horizontal pointing angle | 20 |
| | of a measurement beam3 | |
| 3 | Horizontal pointing angle | −70 |
| | of a measurement beam1 | |
| 4 | Vertical pointing angle of | 22.5 |
| | the measurement beam1 | |
| 5 | Vertical pointing angle of | 112.5 |
| | a measurement beam2 | |
| 6 | Vertical pointing angle of | 22.5 |
| | the measurement beam3 | |
| 7 | Vertical pointing angle of | 112.5 |
| | the measurement beam4 | |
| 8 | Horizontal pointing angle | −20 |
| | of the measurement beam2 | |

In some implementations, the data processing manner may be indicated based on an identifier. For example, based on the identifier, it is determined that data bias processing and disorder processing are used, a bias value of data bias processing is 100, and a parameter of disorder processing is (4 3 1 5 6 7 8 2).

The split inference information may indicate the first device and the second device to perform model split inference on the AI model.

In some implementations, the performing model split inference by the first device and the second device may include:
serving, by the first device, as auxiliary inference of the AI model, and serving, by the second device, as joint inference of the AI model; or
serving, by the first device, as joint inference of the AI model, and serving, by the second device, as auxiliary inference of the AI model.

That the first device serves as auxiliary inference of the AI model and the second device serves as joint inference of the AI model may be as follows: An output of the AI model of the first device is used to assist joint inference by the second device, for example, the output of the AI model of the first device serves as an input of joint inference by the second device. Joint inference by the second device may be performing joint inference by using, as an input of a joint inference model, the output of the AI model of the first device and information obtained by the second device. The information obtained by the second device may be information obtained by the second device by using another AI model, or may be information directly obtained by the second device.

That the first device serves as joint inference of the AI model and the second device serves as auxiliary inference of the AI model may be as follows: An output of the AI model of the second device is used to assist joint inference by the first device, for example, the output of the AI model of the second device serves as an input of joint inference by the first device. Joint inference of the first device may be performing joint inference by using, as an input of a joint inference model, the output of the AI model of the second device and information obtained by the first device. The information obtained by the first device may be information obtained by the first device by using another AI model, or may be information directly obtained by the first device.

Optionally, the split inference information may include at least one of the following:
identifier information of the AI model of the first device;
identifier information of an AI model of the second device;
version information of the AI model of the first device;
version information of the AI model of the second device;
a length of the output data of the AI model of the first device; and
output usage information of the AI model of the first device.

With at least one of the identifier information of the AI model of the first device and the identifier information of the AI model of the second device, the first device and the second device performs model split inference on a same AI model.

In some implementations, the output usage information of the AI model of the first device includes at least one of the following:
position information in a case that the second device performs joint inference, where the position information specifies where the output data from the first device's AI model is mapped within joint inference model input grid; and
indication information, where the indication information is used to indicate joint calculation between the output of the AI model of the first device and an input of the AI model of the second device.

Joint inference by the second device may be that the second device performs joint inference based on an input or an output of the AI model of the second device and an output of the AI model of the first device, and where the output data from the first device's AI model is mapped within joint inference model input grid may be a position existing when the output of the AI model of the first device is used as an input of a joint inference AI model during joint inference. In addition, the second device may have a private model and a joint inference AI model, or the second device only has a joint inference AI model.

Joint calculation may be joint inference such as AI model joint inference, or may be other joint calculation agreed upon by a protocol in some implementations. No limitation is imposed.

With at least one of the length information of the output data and the output usage information, a consistent understanding of an output of a same AI model may reached between the first device and the second device, to avoid mismatched data between the first device and the second device for the output of the AI model, thereby improving inference performance of model split inference. In addition, in the split inference scenario, the second device may not need to understand a specific meaning of the output of the AI model of the first device, provided that an interface between the output of the AI model of the first device and the input of the joint inference model is matched.

In an optional implementation, the AI model description information is AI model description information of the AI model of the first device, and the AI model description information further includes at least one of the following:
identifier information of the AI model of the first device;
a predefined output format indication of the AI model of the first device;
a flexible output format indication of the AI model of the first device;
first cause information, where the first cause information is that a network side uses an inference result of the AI model of a terminal; and
historical evaluation information or predictive evaluation information of the AI model of the first device.

The flexible output format indication may be that an output format of the AI model may be flexibly adjusted based on an actual requirement.

In some implementations, the output format indication may indicate a physical meaning represented by each dimension of an AI model output, where AI model output data may include a data item, and further includes at least one of the following:
a spatial dimension, a frequency domain dimension, a time domain dimension, a cell dimension, and a postprocessing indicator.

The spatial dimension may include at least one of the following:
all transmit beams, all transmit-receive beam pairs, all receive beams, and all transmit-receive antenna ports.

The frequency domain dimension may include at least one of the following:
all frequency bands, a resource block (RB) indication, and a sub-band indication.

The time dimension may include at least one of the following:
a time interval and a quantity of predictions.

The cell dimension indicates a physical cell identity corresponding to the output.

In some implementations, an output data template corresponding to the output format indication may be shown in the following Table 1:

TABLE 1
Output data template

| | | Frequency | | | |
|---|---|---|---|---|---|
| | Spatial | domain | Time domain | Cell | [Postprocessing |
| Data item | dimension | dimension | dimension | dimension | indicator] |
| Predicted optimal | All beams | Not available | Time | NA | NA |
| transmit resource | | (NA) | interval: 40 ms | | |
| identifier | | | Quantity of | | |
| | | | predictions: 8 | | |
| Predicted channel | All antenna | All frequency | Time | NA | NA |
| matrix/eigenvalue/ | ports | bands | interval: 10 ms | | |
| precoding matrix | | Frequency | Quantity of | | |
| indicator (PMI) | | band pattern | predictions: 1 | | |
| Predicted layer 3 | FR1: NA | NA | Time | Physical cell | NA |
| reference signal | FR2: All | | interval: 80 ms | identity: 1, 2, 3 | |
| received power | beams | | Quantity of | | |
| (L3-RSRP) and | | | predictions: 4 | | |
| signal to | | | | | |
| interference plus | | | | | |
| noise ratio (SINR) | | | | | |

The historical evaluation information may be evaluation information of historical inference of the AI model, and the predictive evaluation information may be evaluation information of current inference of the AI model.

In some implementations, the historical evaluation information or the predictive evaluation information includes at least one of the following:
a performance metric and an assessment result.

The performance metric may include at least one of the following:
a system throughput gain;
beam prediction accuracy;
cosine similarity between a predicted channel and a real channel;
a handover failure rate;
a ping-pong handover rate; and
a short-stay rate.

In addition, the performance metric may be a historical or pre-performance metric, and the evaluation result may be a historical or pre-assessment result. In this way, with the assessment result, the second device may determine, based on the assessment result, whether to use the inference result of the AI model in a communication process.

The first cause information may indicate an AI model registration cause.

In the foregoing implementation, with the AI model description information, a consistent understanding of the identifier information, the output format, and the historical evaluation information or the predictive evaluation information of the AI model may be reached between the first device and the second device, so that the second device can better use the inference result of the AI model.

In the foregoing implementation, the first device may be a terminal, and the second device may be an access network device.

In an optional implementation, the AI model description information is AI model description information of the AI model of the first device, and the AI model functionality includes at least one of the following: a to-be-activated AI model functionality of the first device and a deployed AI model functionality of the first device.

The AI model description information further includes at least one of the following:
identifier information of a to-be-activated AI model of the first device; and
identifier information of a deployed AI model of the first device.

The identifier information of the to-be-activated AI model of the first device may be a list of to-be-activated AI models, and the identifier information of the deployed AI model may be a list of deployed AI models.

In this implementation, with the AI model description information, the second device may obtain related information of the to-be-activated or deployed AI model of the first device, to activate the AI model of the first device based on a requirement, so that a consistent understanding of the to-be-activated AI model of the first device is reached between the first device and the second device, and the second device implements activation control over the AI model of the first device.

In the foregoing implementation, the first device may be a terminal, the second device may be an access network device, and activation control over the AI model is at the second device.

Optionally, the AI model description information further includes at least one of the following:
first identifier information of the AI model of the first device, where the first identifier information includes at least one of the following: the identifier information of the to-be-activated model of the first device;
historical evaluation information or predictive evaluation information of the AI model of the first device;
a lifecycle control authority over the AI model of the first device; and
second cause information, where the second cause information is used to indicate that a trigger cause of the first information is activating the AI model of the first device.

The second cause information may indicate an AI model registration cause.

A lifecycle of the AI model may be an activation time cycle of the AI model, or a time cycle of running or working of the AI model.

The lifecycle control authority may include at least one of the following:
a lifecycle control authority of the first device over the AI model of the first device; and
a lifecycle control authority of the second device over the AI model of the first device.

In this way, at least one of the first device and the second device can be supported to control the lifecycle of the AI model of the first device, to improve flexibility of lifecycle control over the AI model.

In some implementations, the lifecycle control authority may include at least one of the following:
a model activation control right;
a model deactivation control right;
a model switching control right;
a model fallback control right; and
a model monitoring control right.

In this way, flexible control over at least one of the activation control authority, the deactivation control authority, the switching control authority, the fallback control authority, and the monitoring control authority of the AI model can be implemented, to improve flexibility of lifecycle control over the AI model.

In an optional implementation, the AI model description information AI model description information of the AI model of the first device, and the AI model functionality includes at least one of the following: a to-be-monitored AI model functionality of the first device and a non-to-be-monitored AI model functionality of the first device.

The AI model description information further includes at least one of the following:
identifier information of a to-be-monitored AI model of the first device; and
identifier information of a non-to-be-monitored AI model of the first device.

The AI model functionality of the first device may be the non-to-be-monitored AI p model functionality of the first device.

The to-be-monitored AI model includes an activated AI model and/or an inactivated to-be-monitored AI model. The identifier information of the to-be-monitored AI model of the first device may be a list of to-be-monitored AI models, and the identifier information of the non-to-be-monitored AI model may be a list of non-to-be-monitored AI models.

The to-be-monitored AI model may be at the first device side and is to be monitored by the second device.

In this implementation, with the AI model description information, the second device may monitor the AI model corresponding to the first device, to improve a monitoring effect of the AI model.

In the foregoing implementation, the first device may be a terminal, the second device may be an access network device or a core network device, and AI model monitoring is on the second device.

The to-be-monitored AI model of the first device may include at least one of the following:
an activated AI model of the first device; and
an inactivated to-be-monitored AI model of the first device.

In this way, the activated AI model or the inactivated AI model can be monitored.

In some implementations, the AI model description information may further include at least one of the following:
an associated performance metric of the AI model of the first device;
the historical evaluation information or the predictive evaluation information of the AI model of the first device;
status information of the AI model of the first device;
a first AI model data collection condition, where the first AI model data collection condition includes a monitoring data collection condition; and
third cause information, where the third cause information is used to indicate that the trigger cause of the first information is monitoring the AI model of the first device.

The associated performance metric of the AI model may be a performance metric that may affect the network after model activation, for example, an associated performance metric of the AI model functionality or an associated performance metric of the AI model itself. In this way, the associated performance metric of the AI model is sent, so that it helps the network perform key monitoring, to avoid adversely affecting the network. In addition, the associated performance metric of the AI model may be used as a reference indicator for monitoring model performance by the network.

With the historical evaluation information or the predictive evaluation information of the AI model, the second device may flexibly select, based on a requirement and the historical evaluation information or the predictive evaluation information, information corresponding to the first device. For example, in a case that the historical evaluation information or the predictive evaluation information is relatively poor, the second device obtains information obtained by the first device through actual measurement instead of information predicted by the AI model. For example, in a case that the historical evaluation information or the predictive evaluation information is relatively good, the second device uses information predicted by the AI model.

The status information of the AI model may be an activation status of the AI model, such as activated or inactivated. In addition, the status information of the AI model may be described based on a single model, that is, indicate a status for each AI model, or may be represented by using a list of to-be-activated or activated AI models.

With the status of the AI model, the second device may learn of the status of the AI model of the first device, or monitor the model based on a requirement. For example, key monitoring is performed on the activated AI model, to avoid severely affecting the network. For the inactivated model, because no direct impact is caused on the network, monitoring may be relaxed. Alternatively, the status of the AI model of the first device is flexibly controlled based on a requirement.

With the first AI model data collection condition, data that better matches the AI model may be collected, thereby improving prediction performance of the AI model and more accurately assessing model inference performance.

The third cause information may indicate an AI model registration cause. With the third cause, the second device may learn of a cause why the first device sends the first information, and then perform corresponding processing based on the cause.

In an optional implementation, the AI model description information further includes at least one of the following:
a second AI model data collection condition, where the second AI model data collection condition is a training data collection condition of the AI model of the first device; and
fourth cause information, where the fourth cause information is used to indicate that the trigger cause of the first information is that the network side assists the first device in collecting training data of the AI model of the first device.

The second AI model data collection condition may be a collection condition under which the second device assists in collecting training data for the AI model of the first device. In this way, with the second AI model data collection condition, the second device may collect, for the first device, a dataset that is more conducive to learning an input-label relationship, thereby improving prediction performance of a trained AI model.

The fourth cause information may indicate a registration cause. With the fourth cause, the network side may assist the first device in collecting the training data of the AI model of the first device, thereby improving prediction performance of the AI model through training. In addition, collection herein may be that the network side collects a part of training data of the AI model, another part of training data is collected by the first device, and finally the first device obtains a complete data set.

In the foregoing implementation, the first device may be a terminal, the second device may be an access network device, and the access network device assists the terminal in data collection for model update.

In an optional implementation, the AI model description information further includes at least one of the following:
a third AI model data collection condition, where the third AI model data collection condition is a training data collection condition of the AI model of the first device;
AI model training data configuration information; and
fifth cause information, where the fifth cause information is used to indicate that the trigger cause of the first information is that the network side collects training data of the AI model of the first device.

The third AI model data collection condition may be a collection condition under which the second device collects the training data for the AI model of the first device. In this way, with the third AI model data collection condition, the second device may collect input and label data required for training the AI model of the first device, thereby improving prediction performance of the AI model through training.

The fifth cause information may indicate a registration cause. With the fifth cause, the network side may collect the training data of the AI model of the first device, thereby improving prediction performance of the AI model through training. In addition, collection herein may be that the network side collects all training data of the AI model.

In the foregoing implementation, the first device may be a terminal, the second device may be an access network device, and the access network device performs data collection for model update.

Optionally, the AI model training data configuration information includes at least one of the following:
an input data item of the AI model;
a label data item of the AI model;
an input data format of the AI model;
an output data format of the AI model;
a quantity of samples of the AI model;
a data storage requirement of the AI model; and
a third-party training configuration of the AI model.

The input data item may be a data item that is input to the AI model, and the label data item may be a label data item of a training sample of the AI model.

The input data item and the label data item may include at least one of the following:
reference signal received power (RSRP) of a beam channel;
reference signal received quality (RSRQ) of the beam channel;
a signal to interference plus noise ratio (SINR) of the beam channel;
RSRP of a cell channel;
RSRQ of the cell channel;
an SINR of the cell channel;
a received signal strength indicator (RSSI) of the cell channel;
a cell channel impulse response;
a channel characteristic matrix;
a precoding matrix indicator (PMI);
a rank indication (RI); and
a channel quality indication (CQI).

With at least one of the input data item of the AI model, the label data item of the AI model, the input data format of the AI model, and the output data format of the AI model, the second device may collect input and label data required for training, thereby improving prediction performance of the AI model through model training.

The data storage requirement of the AI model may be a storage requirement for storing required training data by the second device.

The third-party training configuration of the AI model may include a third-party identifier such as a destination internet protocol (IP) address. The third-party configuration may be, for example, third-party server information and a third-party application programming interface (API).

Optionally, before the sending, by a first device, first information to a second device, the method further includes:
receiving, by the first device, a first request sent by the second device, where the first request is used to request a to-be-collected data set.

The first request may be used to request the second device to collect the data set.

In this implementation, with the second request, the second device may provide the first device with data required by the first device, and the first device does not need to perform collection, thereby reducing power consumption of the first device.

In an optional implementation, before the sending, by a first device, first information to a second device, the method further includes:
receiving, by the first device, a second request sent by the second device, where the second request is used to request to obtain the first information.

In this implementation, the second request may be used to request the first device to provide the first information to the second device in a timely manner. Therefore, the second device may determine a corresponding AI model based on the first information, to implement on-demand sending of the first information, thereby saving transmission resources.

It should be noted that the first information may also be sent by the first device based on a protocol agreement or a pre-configuration.

In an optional implementation, before the sending, by a first device, first information to a second device, the method further includes:
receiving, by the first device, second information, where the second information includes information about at least one AI model.

The AI model description information includes:
description information of an AI model selected by the first device based on the second information.

The first device may be an AI model deployment device, and the second device may be an access network device or a core network device, and may be specifically a model registration center or a model identification center. In this implementation, model selection is on the first device, for example, the terminal selects a model.

The second information may be received second information sent by an access network device or a core network device. For example, in a case that the second device is an access network device, the first device may receive second information sent by the access network device or the core network device.

In the foregoing implementation, the following may be implemented:

The first device receives the second information from the core network device, and then the first device sends the first information to the access network device, to register the AI model with the access network device; or
the first device receives the second information from the access network device, and then the first device sends the first information to the access network device, to register the AI model with the access network device; or
the first device receives the second information from a first access network device, and then the first device sends the first information to a second access network device, to register the AI model with the second access network device.

For example, the first device may be deployed with the AI model in a 3GPP unaware manner, and then register the model with the base station, and a corresponding cause may include the first cause to the fifth cause; or
the first device may determine the deployed model by receiving the second information, and then register the model with the base station, and a corresponding cause may include the first cause to the fifth cause.

In this implementation, with the second information, the first device may select the AI model, so that the selected AI model can better match the first device, thereby improving communication performance of the first device.

Optionally, the information about the at least one AI model includes at least one of the following:
developer information of the at least one AI model;
evaluation information of the at least one AI model; and
an inference condition of the at least one AI model.

The evaluation information may include a historical evaluation result, a performance ranking, and cumulative online time.

In some implementations, the inference condition of the at least one AI model may include at least one of the following:

a running range of the at least one AI model, a connection condition of the at least one AI model, a computing power condition of the at least one AI model, an algorithm condition of the at least one AI model, and a data condition of the at least one AI model.

The computing power condition may include at least one of the following:
computing power, for example, floating-point operations per second (FLOPS);
storage;
a total amount of calculation; and
power consumption.

The algorithm condition may include at least one of the following:
a supported learning framework;
a supported version;
a supported operator;
a supported library;
a supported model structure; and
a supported development environment.

With the inference condition of the at least one AI model, the first device can better select an AI model that matches the first device, thereby improving communication performance of the first device.

In some implementations, the running range of the at least one AI model may include:
a quantity of devices involved in an inference result of the at least one AI model.

In some implementations, the connection condition of the at least one AI model may include at least one of the following:
a terminal configuration of the at least one AI model and a network-side configuration of the at least one AI model;

In some implementations, the data condition of the at least one AI model may include at least one of the following:
a data item of the at least one AI model and a data processing indicator of the at least one AI model.

The data processing indicator may include at least one of the following:
a preprocessing indicator and a postprocessing indicator.

The preprocessing indicator may include:
a preprocessing function indication, a one-hot encoding dictionary configuration, a data normalization parameter configuration, a data regularization parameter configuration, and a data standardization parameter configuration.

The one-hot encoding dictionary configuration is used to map data with a same physical meaning to a same one-hot code.

The postprocessing indicator may include at least one of the following:
a sparsification configuration indication;
a privatization configuration indication;
postprocessing on an output of an entire model; and
postprocessing on an output of a sub-model of the model.

In the foregoing implementation, with at least one of the running range, the connection condition, the computing power condition, the algorithm condition, and the data condition, the first device can better select an AI model that matches the first device, thereby improving communication performance of the first device.

In an optional implementation, the first capability information includes:
a connection capability, a computing power capability, an algorithm capability, and a data capability.

The connection capability may be a configuration of the first device. For example, the connection capability may include a configuration for connecting to a network by the first device.

The data capability may include at least one of the following:
a data item that can be provided and a supported data processing indicator.

The data processing indicator includes a specified neural network and/or a specified processing function. For the processing function, refer to corresponding descriptions in the foregoing implementations. Details are not described herein again.

The computing power capability may include at least one of the following: computing power, for example, FLOPS;
storage;
a total amount of calculation; and
power consumption.

The algorithm capability may include at least one of the following:
a supported learning framework;
a supported version;
a supported operator;
a supported library;
a supported model structure; and
a supported development environment.

In this implementation, with the connection capability, the computing power capability, the algorithm capability, and the data capability, the second device may select an AI model that better matches the first device, thereby improving communication performance of the first device.

In an implementation, after the sending, by a first device, first information to a second device, the method further includes:
receiving, by the first device, third information sent by the second device, where the third information includes information about an AI model or an AI model functionality selected by the second device based on the first information.

The information about the AI model or the AI model functionality may be an AI model that is selected by the second device based on the capability information and that matches a capability of the first device, thereby improving communication performance of the first device.

In this implementation, the first device may be a model deployment device, such as a terminal. The second device may be a model registration center or a model identification center, such as an access network device or a core network device. In this implementation, the AI model is selected by the second device.

In another implementation, before the sending, by a first device, first information to a second device, the method further includes:
receiving, by the first device, fourth information sent by the second device, where the fourth information includes information about at least one AI model; and
determining, by the first device, at least one of an AI model and an AI model functionality based on the fourth information.

The information about the at least one AI model may be an AI model that is selected by the second device based on the capability information and that matches a capability of the first device. Then, the first device selects an AI model from the at least one model, so that the selected AI better matches the first device, thereby improving communication performance of the first device.

In this implementation, the first device may be a model deployment device, such as a terminal. The second device may be a model registration center or a model identification center, such as an access network device or a core network device. In this implementation, the AI model is selected by the first device.

In the embodiments of this application, the first device sends the first information to the second device, where the first information includes at least one of the following: the AI model description information, where the AI model description information is used to describe the AI model corresponding to the first device; and the first capability information associated with an AI model, where the first capability information is used to select an AI model. The first information is sent, so that a consistent understanding of the AI model corresponding to the first device can be more easily reached between the first device and the second device, thereby helping improve communication performance between the first device and the second device.

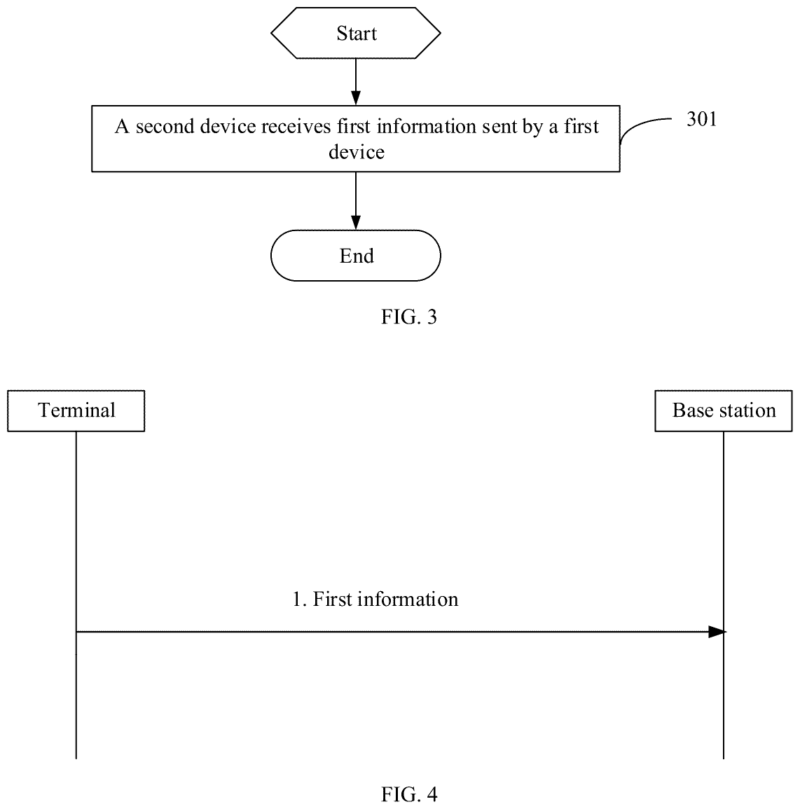

Referring to FIG. 3, FIG. 3 is a flowchart of a model information transmission method according to an embodiment of this application. As shown in FIG. 3, the method includes the following steps.

Step 301: A second device receives first information sent by a first device, where the first information includes at least one of the following:
AI model description information, where the AI model description information is used to describe an AI model corresponding to the first device; and
first capability information associated with an AI model, where the first capability information is used to select an AI model.

Optionally, the AI model description information includes at least one of the following:
an AI model functionality, an AI model usage condition, and AI model identifier information.

Optionally, the AI model description information is AI model description information of the AI model of the first device, and the AI model description information further includes at least one of the following:
identifier information of the AI model of the first device;
a predefined output format indication of the AI model of the first device;
a flexible output format indication of the AI model of the first device;
first cause information, where the first cause information is used to indicate that a trigger cause of the first information is that a network side uses an inference result of the AI model of a terminal; and
historical evaluation information or predictive evaluation information of the AI model of the first device.

Optionally, the historical evaluation information or the predictive evaluation information includes at least one of the following:
a performance metric and an assessment result.

Optionally, the AI model description information is AI model description information of the AI model of the first device, and the AI model functionality includes at least one of the following: a to-be-activated AI model functionality of the first device and a deployed AI model functionality of the first device.

The AI model description information further includes at least one of the following:
identifier information of a to-be-activated AI model of the first device; and
identifier information of a deployed AI model of the first device.

Optionally, the AI model description information further includes at least one of the
first identifier information of the AI model of the first device, where the first identifier information includes at least one of the following: the identifier information of the to-be-activated model of the first device;
historical evaluation information or predictive evaluation information of the AI model of the first device;
a lifecycle control authority over the AI model of the first device; and
second cause information, where the second cause information is used to indicate that a trigger cause of the first information is activating the AI model of the first device.

Optionally, the lifecycle control authority includes at least one of the following:
a lifecycle control authority of the first device over the AI model of the first device; and
a lifecycle control authority of the second device over the AI model of the first device.

Optionally, the lifecycle control authority includes at least one of the following:
a model activation control right;
a model deactivation control right;
a model switching control right;
a model fallback control right; and
a model monitoring control right.

Optionally, the AI model usage condition includes at least one of the following:
an AI model configuration condition, an AI model scenario condition, and an AI model data condition.

Optionally, the AI model data condition includes at least one of the following:
network-side additional information, where the network-side additional information is used to indicate the second device to provide additional information for the AI model of the first device; and
a network-side additional configuration, where the network-side additional configuration is used to indicate the second device to perform related configuration for the AI model of the first device;
a network data processing indicator, where the network data processing indicator is used to indicate at least one of the following: a data processing manner for input data of the AI model of the first device and a data processing manner for output data of the AI model of the first device; and
split inference information, where the split inference information is information for performing model split inference by the first device and the second device.

Optionally, the performing model split inference by the first device and the second device includes:
serving, by the first device, as auxiliary inference of the AI model, and serving, by the second device, as joint inference of the AI model; or
serving, by the first device, as joint inference of the AI model, and serving, by the second device, as auxiliary inference of the AI model.

Optionally, the split inference information includes at least one of the following:
identifier information of the AI model of the first device;
identifier information of an AI model of the second device;
version information of the AI model of the first device;
version information of the AI model of the second device;
a length of the output data of the AI model of the first device; and
output usage information of the AI model of the first device.

Optionally, the output usage information of the AI model of the first device includes at least one of the following:
position information in a case that the second device performs joint inference, where the position information specifies where the output data from the first device's AI model is mapped within joint inference model input grid; and
indication information, where the indication information is used to indicate joint calculation between the output of the AI model of the first device and an input of the AI model of the second device.

Optionally, the AI model description information AI model description information of the AI model of the first device, and the AI model functionality includes at least one of the following: a to-be-monitored AI model functionality of the first device and a non-to-be-monitored AI model functionality of the first device.

The AI model description information further includes:

identifier information of a to-be-monitored AI model of the terminal; and
identifier information of a non-to-be-monitored AI model of the terminal.

Optionally, the to-be-monitored AI model of the first device includes at least one of the following:
an activated AI model of the first device; and
an inactivated to-be-monitored AI model of the first device.

Optionally, the AI model description information further includes at least one of the
an associated performance metric of the AI model of the first device;
the historical evaluation information or the predictive evaluation information of the AI model of the first device;
status information of the AI model of the first device;
a first AI model data collection condition, where the first AI model data collection condition includes at least one of a monitoring data collection condition; and
third cause information, where the third cause information is used to indicate that the trigger cause of the first information is monitoring the AI model of the first device.

Optionally, the AI model description information further includes at least one of the following:
a second AI model data collection condition, where the second AI model data collection condition is a training data collection condition of the AI model of the first device; and
fourth cause information, where the fourth cause information is used to indicate that the trigger cause of the first information is that the network side assists the first device in collecting training data of the AI model of the first device.

Optionally, the AI model description information further includes at least one of the following:
a third AI model data collection condition, where the third AI model data collection condition is a training data collection condition of the AI model of the first device;
AI model training data configuration information; and
fifth cause information, where the fifth cause information is used to indicate that the trigger cause of the first information is that the network side collects training data of the AI model of the first device.

Optionally, the AI model training data configuration information includes at least one of the following:
an input data item of the AI model;
a label data item of the AI model;
an input data format of the AI model;
an output data format of the AI model;
a quantity of samples of the AI model;
a data storage requirement of the AI model; and
a third-party training configuration of the AI model.

Optionally, before the receiving, by a second device, first information sent by a first device, the method further includes:
sending, by the second device, a first request to the first device, where the first request is used to request a to-be-collected data set.

Optionally, before the receiving, by a second device, first information sent by a first device, the method further includes:
sending, by the second device, a second request to the first device, where the second request is used to request to obtain the first information.

Optionally, before the receiving, by a second device, first information sent by a first device, the method further includes:
sending, by the second device, second information to the first device, where the second information includes information about at least one AI model; and

The AI model description information includes:
description information of an AI model selected by the first device based on the second information.

Optionally, the information about the at least one AI model includes at least one of the following:
developer information of the at least one AI model;
evaluation information of the at least one AI model; and
an inference condition of the at least one AI model.

Optionally, the inference condition of the at least one AI model includes at least one of the following:
a running range of the at least one AI model, a connection condition of the at least one AI model, a computing power condition of the at least one AI model, an algorithm condition of the at least one AI model, and a data condition of the at least one AI model.

Optionally, the running range of the at least one AI model includes:
a quantity of devices involved in an inference result of the at least one AI model;
and/or the connection condition of the at least one AI model includes at least one of the following:
a terminal configuration of the at least one AI model and a network-side configuration of the at least one AI model;
and/or the data condition of the at least one AI model includes at least one of the
a data item of the at least one AI model and a data processing indicator of the at least one AI model.

Optionally, the data processing indicator includes at least one of the following:
a preprocessing indicator and a postprocessing indicator.

Optionally, the preprocessing indicator includes:
a preprocessing function indication, a one-hot encoding dictionary configuration, a data normalization parameter configuration, a data regularization parameter configuration, and a data standardization parameter configuration; and

The postprocessing indicator includes at least one of the following:
a sparsification configuration indication;
a privatization configuration indication;
postprocessing on an output of an entire model; and
postprocessing on an output of a sub-model of the model.

Optionally, before the sending, by the second device, second information to the first device, the method further includes:
determining, by the second device, the at least one AI model based on at least one of an inference condition, information about the second device, and information about the first device.

Optionally, before the determining, by the second device, the at least one AI model based on at least one of an inference condition, information about the second device, and information about the first device, the method further includes:
receiving, by the second device, fifth information sent by a third device, where the fifth information includes AI model description information.

Optionally, the first capability information includes:
a connection capability, a computing power capability, an algorithm capability, and a data capability.

The connection capability includes a configuration for connecting to a network by the first device;
and/or the data capability includes at least one of the following:
a data item that can be provided and a supported data processing indicator.

Optionally, after the receiving, by a second device, first information sent by a first device, the method further includes:
sending, by the second device, third information to the first device, where the third information includes information about an AI model or an AI model functionality selected by the second device based on the first information.

Optionally, before the receiving, by a second device, first information sent by a first device, the method further includes:
sending, by the second device, fourth information to the first device, where the fourth information includes information about at least one AI model.

It should be noted that this embodiment is used as an implementation corresponding to the second device in the embodiment shown in FIG. 2. For a specific implementation of this embodiment, refer to related descriptions of the embodiment shown in FIG. 2. To avoid repetition, details are not described in this embodiment.

A plurality of embodiments are used below to describe, by using an example, the model information transmission method provided in the embodiments of this application.

The following scenarios are used as examples in the following plurality of embodiments:

The first device is a model deployment device, the second device is a model registration center or a model identification center, and the third device is a model production device.

The following plurality of embodiments may include a plurality of scenarios shown in Table 1.

TABLE 1

| | Whether a | | | |
|---|---|---|---|---|
| | terminal has | | | Interaction |
| Scenario | a model | Related operation | Basic operation | information |
| 1a | The terminal | Model selection | A terminal capability | Terminal−>registration |
| | has no model | on a network | is reported during | center |
| | | | registration, so that a | AI capability |
| | | | registration center (for | |
| | | | example, a base station | |
| | | | or a core network | |
| | | | function) selects a | |
| | | | model and delivers the | |
| | | | model to the terminal | |
| 1b | The terminal | Model selection | 1) A registration center | Registration |
| | has no model | on the terminal | (for example, a base | center−>terminal |
| | | | station or a core | Model list |
| | | | network function) | |
| | | | broadcasts a model list, | |
| | | | and the terminal selects | |
| | | | a model based on a | |
| | | | capability of the terminal | |
| 1c | The terminal | | 2) The terminal reports | Terminal−>registration |
| | has no model | | an AI capability, and a | center |
| | | | registration center (for | AI capability |
| | | | example, a base station | Registration |
| | | | or a core network | center−>terminal |
| | | | function) performs | Model list |
| | | | model filtering based on | |
| | | | the AI capability, and | |
| | | | sends a candidate model | |
| | | | to the terminal | |
| 2 | The terminal | Activation control | The terminal reports a | Terminal−>base station |
| | has a model | on a base station | list of to-be-activated | 1) List of to-be-activated |
| | | | models, and the base | models |
| | | | station selects a list of | 2) Usage condition |
| | | | models that can be | (including a configuration |
| | | | activated | condition, a scenario |
| | | | | condition, and an |
| | | | | inference data condition) |
| | | | | 3) Terminal AI capability |
| | | | | (optional) |
| | | | | 4) Historical evaluation |
| | | | | result (optional) |
| | | | | 5) AI lifecycle control |
| | | | | authority (optional) |
| | | | | Base station−>terminal |
| | | | | 1) List of activated |
| | | | | models |
| 3a | | Model monitoring | The terminal reports a | Terminal−>base station |
| | | on a base station | list of activated models, | 1) List of activated or |
| | | (the terminal has | and the base station | to-be-monitored models |
| | | activated a model, | starts to monitor model | 2) Associated KPI |
| | | after inference or | performance | (optional) |
| | | before inference) | | 3) Historical evaluation |
| | | | | result (optional) |
| 3b | | Usage of an | The terminal sends the | Terminal−>base station |
| | | inference result on | inference result to the | 1) Usage condition |
| | | a base station (the | base station, and the | (configuration condition |
| | | terminal has | base station uses the | and scenario condition |
| | | activated a model, | inference result (before | of the base station) |
| | | before inference) | inference, sent once, not | 2) Predefined output |
| | | | carried in information | format indication |
| | | | during each inference) | (optional) |
| | | | 1) Predefined output | 3) Flexible output format |
| | | | indication | indication (optional) |
| | | | 2) The base station | 4) Historical evaluation |
| | | | determines, based on a | result (optional) |
| | | | usage condition, whether | |
| | | | the result is available | |
| | | | 3) Flexible output | |
| | | | format indication | |
| 4a | The terminal | The terminal | 1. The terminal sends a | Terminal−>base station |
| | has a model | performs data | training data collection | 1) Usage condition |
| | | collection for | condition to the base | 2) Data collection |
| | | model update, and | station | condition |
| | | a base station | | |
| | | provides assistance | | |
| | | (for example, | | |
| | | meta-learning, | | |
| | | where update needs | | |
| | | to be performed | | |
| | | before usage) | | |
| 4b | The terminal | Training data | 1. The terminal sends a | Terminal−>base station |
| | has a model | collection on a | training data collection | 1) Usage condition |
| | or has no | network | condition to the base | 2) Data collection |
| | model | | station | condition |
| | | | | 3) Input and label data |
| | | | | items |
| | | | | 4) Input data format and |
| | | | | output data format |
| | | | | (optional) |
| | | | | 5) Quantity of samples |
| | | | | 6) Storage requirement |
| | | | | 7) Third-party training |
| | | | | configuration |

Embodiment 1 (scenario 3b): Usage of an inference result is on a base station, the first device is a terminal, and the second device is a base station.

In this embodiment, as shown in FIG. 4, the following step is included:

The first device sends first information to the second device.

The first information includes a model functionality and a model usage condition, and may further include at least one of the following:
a model monitoring result of the first device;
a model identifier;
a predefined output format indication;
a flexible output format indication; and
a registration cause.

The registration cause corresponding to this scenario is that a network uses a model inference result, and the model usage condition includes a configuration condition and a scenario condition of the second device.

Optionally, before the first device sends the first information to the second device, the second device requests an activated AI model or functionality from the first device.

Embodiment 2 (scenario 2): Activation control is on a base station, the first device is a terminal, and the second device is a base station.

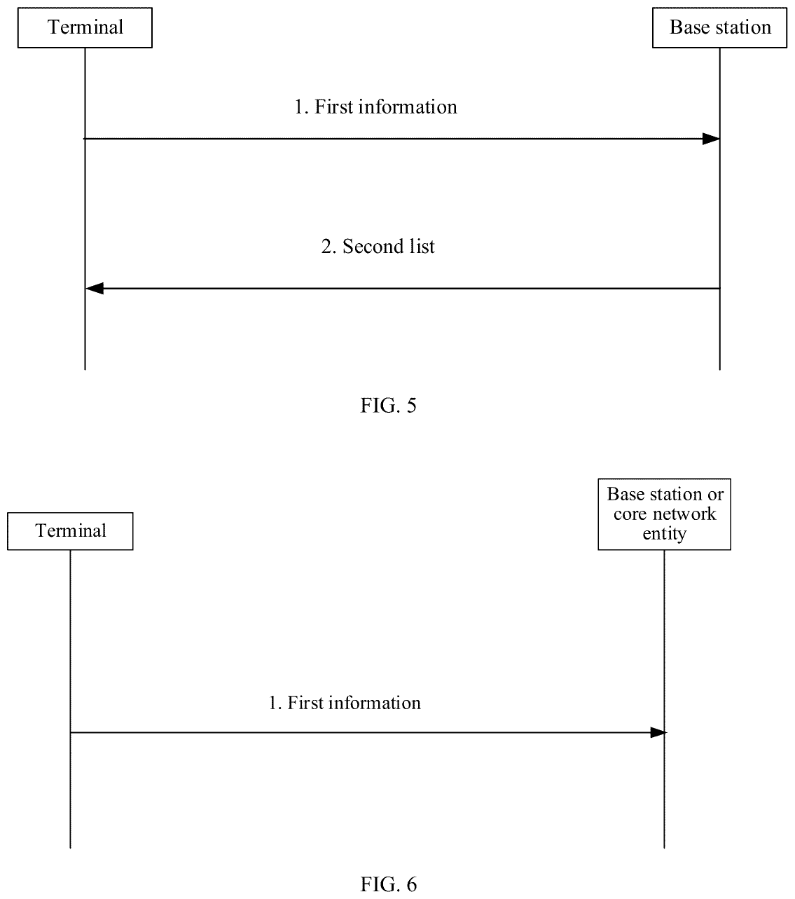

In this embodiment, as shown in FIG. 5, the following step is included:

The first device sends first information to the second device.

The first information includes a model functionality, a first list, and a model usage condition, and further includes at least one of the following:
a model identifier;
a first capability, where the first capability may include at least one of a connection capability, a computing power capability, an algorithm capability, and a data capability;
historical evaluation information or predictive evaluation information;
an AI model lifecycle control authority; and
a registration cause.

The first list includes at least one of the following:
identifier information of a to-be-activated AI model of the first device; and identifier information of a deployed AI model of the first device.

The identifier information of the to-be-activated AI model of the first device may be a list of to-be-activated AI models, and the identifier information of the deployed AI model may be a list of deployed AI models.

In this embodiment, as shown in FIG. 5, the following step is further included:

The first device receives a second list sent by the second device.

The second list is a list of activated models or functionalities that is indicated by the second device.

The AI lifecycle control authority indicates an operation over which the first device has a control authority and/or an operation over which the second device has a control authority.

In this embodiment, the registration cause is activation control. The AI lifecycle control authority includes at least one of the following:
a model activation control right;
a model deactivation control right;
a model switching control right;
a model fallback control right; and
a model monitoring control right.

In this embodiment, the model usage condition includes a configuration and a scenario condition of the second device, and may further include a data condition. The data condition includes:
network-side additional information;
a network-side additional configuration;
a network data processing indicator; and
a split inference condition.

The network data processing indicator determines a specified processing function.

The network data processing indicator may also be indicated by a user group identifier. A same user group uses a same data processing indicator.

In addition, optionally, before the first device sends the first information to the second device, the second device requests a to-be-activated AI model or functionality from the first device.

Embodiment 3 (scenario 3a): Model monitoring is on the second device, the first device is a terminal, and the second device is a base station or a core network entity.

In this embodiment, as shown in FIG. 6, the following step is included:

The first device sends first information to the second device.

The first information includes a model functionality, a third list, and a model usage condition, and may further include the following information:
a model identifier;
a performance metric associated with a functionality;
historical evaluation information or predictive evaluation information;
a current status;
a data collection condition; and
a registration cause.

The third list includes at least one of the following:
identifier information of a to-be-monitored AI model of the first device; and
identifier information of a non-to-be-monitored AI model of the first device.

The identifier information of the to-be-monitored AI model of the first device may be a list of to-be-monitored AI models, and the identifier information of the non-to-be-monitored AI model may be a list of non-to-be-monitored AI models.

In this embodiment, the registration cause is model monitoring. The model usage condition includes a configuration condition and a scenario condition of the second device, and the data collection condition is a monitoring data collection condition.

The performance metric associated with the model or the functionality may be used as a reference indicator for monitoring model performance by a network.

Optionally, before the first device sends the first information to the second device, the second device may request a to-be-monitored AI model or functionality from the first device.

Embodiment 4 (scenario 4a): A network assists a terminal in collecting data for model update, the first device is a terminal, and the second device is a base station.

In this embodiment, a model may be a model trained through meta-learning. After the model is deployed, the model needs to be updated before inference. Therefore, after the model is deployed, the terminal needs to collect a small part of training data first.

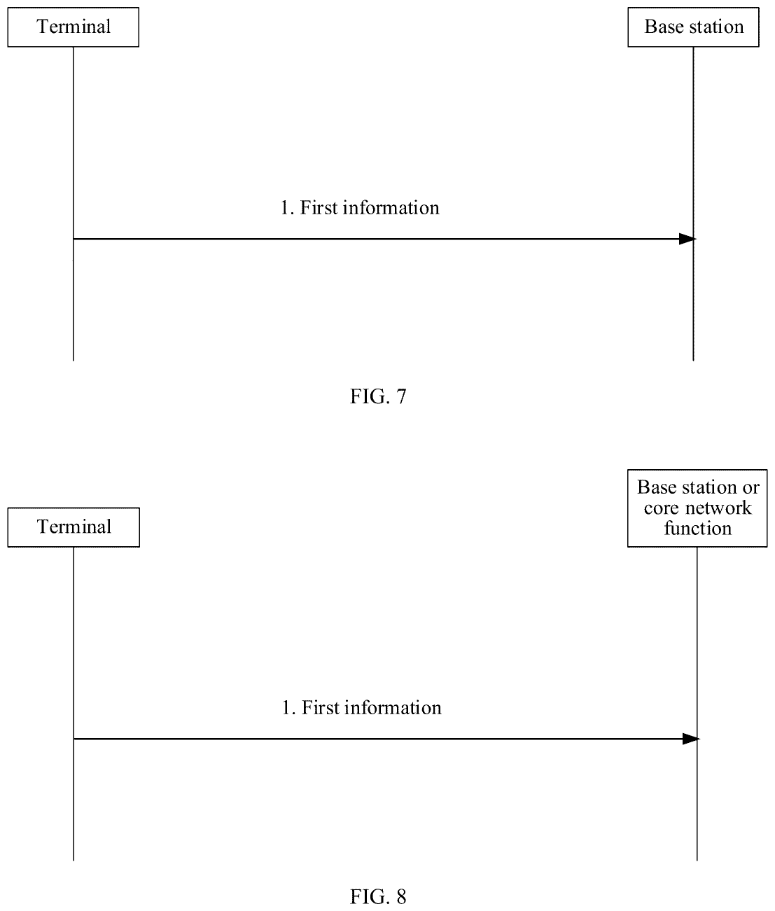

As shown in FIG. 7, the following step is included:

The first device sends first information to the second device. The first information includes a model usage condition and a data collection condition. The first information may further include a registration cause.

In this embodiment, the registration cause is training data collection. The model usage condition includes a configuration condition and a scenario condition of the second device, and the data collection condition is a training data collection condition.

Embodiment 5 (scenario 4b): The second device collects data, the first device is a terminal, and the second device is a base station or a core network function.

In this embodiment, as shown in FIG. 8, the following step is included:

The first device sends first information to the second device.

The first information includes a model usage condition and a data collection condition, and may further include at least one of the following:
input and label data items;
an input data format and an output data format;
a quantity of samples;
a storage requirement;
a third-party training configuration; and
a registration cause.

The third-party training configuration includes a third-party identifier and a destination IP address.

In this embodiment, the registration cause is training data collection on a network, the model usage condition includes a configuration condition and a scenario condition of the second device, and the data collection condition is a training data collection condition.

Before the first device sends the first information to the second device, the second device may request a to-be-collected dataset from the first device.

Embodiment 6 (scenario 1b): Model selection is on a terminal, the first device is a terminal, and the second device is a base station or a core network function, where the first device is a model deployment device, and the second device may be a model registration center or a model identification center.

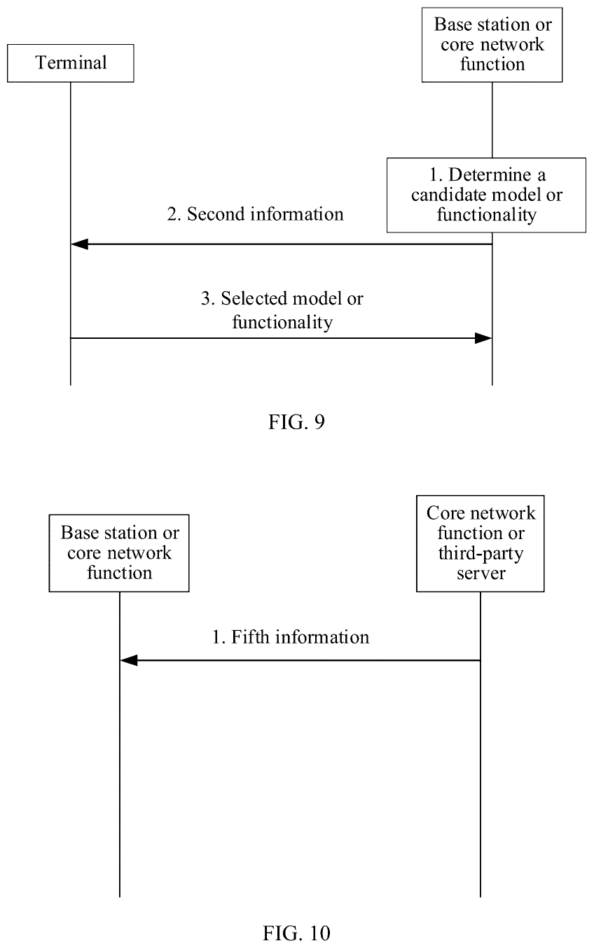

In this embodiment, as shown in FIG. 9, the following steps are included:

The first device receives second information from the second device; and
the first device selects a model or a functionality, and feeds back a selection result to the second device.

The second information includes developer information, model evaluation, and an inference condition. Model evaluation includes a historical evaluation result, a performance ranking, and cumulative online time. The inference condition includes a running range, a connection condition, a computing power condition, an algorithm condition, and a data condition.

The running range includes a quantity of involved terminals and base stations, and includes at least one of the following:
one base station and one terminal;
a plurality of base stations and one terminal;
one terminal and a plurality of base stations; and
a plurality of base stations and a plurality of terminals.

The connection condition includes a valid terminal configuration and a valid base station configuration.

The data condition includes a data item and a data processing indicator. The data processing indicator includes a specified neural network and/or a specified processing function.

As shown in FIG. 9, the following step is further included:

The second device determines a candidate model or functionality based on the inference condition and information about the base station and the terminal.

Embodiment 7 (before scenario 1): A registration center obtains a model from a model production device, the second device is a base station or a core network function, and the third device is a core network function or a third-party server, where the second device is a model registration center or a model identification center, and the third device is a model production device.

As shown in FIG. 10, the following step is included:

The second device receives fifth information sent by the third device.

The fifth information includes a model functionality, developer information, model evaluation, and an inference condition, and may further include a model identifier and/or a registration cause.

Model evaluation includes a historical evaluation result, a performance ranking, and cumulative online time. The inference condition includes a running range, a connection condition, a computing power condition, an algorithm condition, and a data condition.

The running range includes a quantity of involved terminals and base stations, and includes at least one of the following:
one base station and one terminal;
a plurality of base stations and one terminal;
one terminal and a plurality of base stations; and
a plurality of base stations and a plurality of terminals.

The connection condition includes a valid terminal configuration and a valid base station configuration.

The data condition includes a data item and a data processing indicator. The data processing indicator includes a specified neural network and/or a specified processing function.

Before the second device receives the fifth information sent by the third device, the second device may query the third device about whether there is a model or a functionality that needs to be registered.

Embodiment 8 (scenario 1a): Model selection is on the second device, the first device is a terminal, and the second device is a base station or a core network function, where the first device is a model deployment device, and the second device is a model registration center or a model identification center.

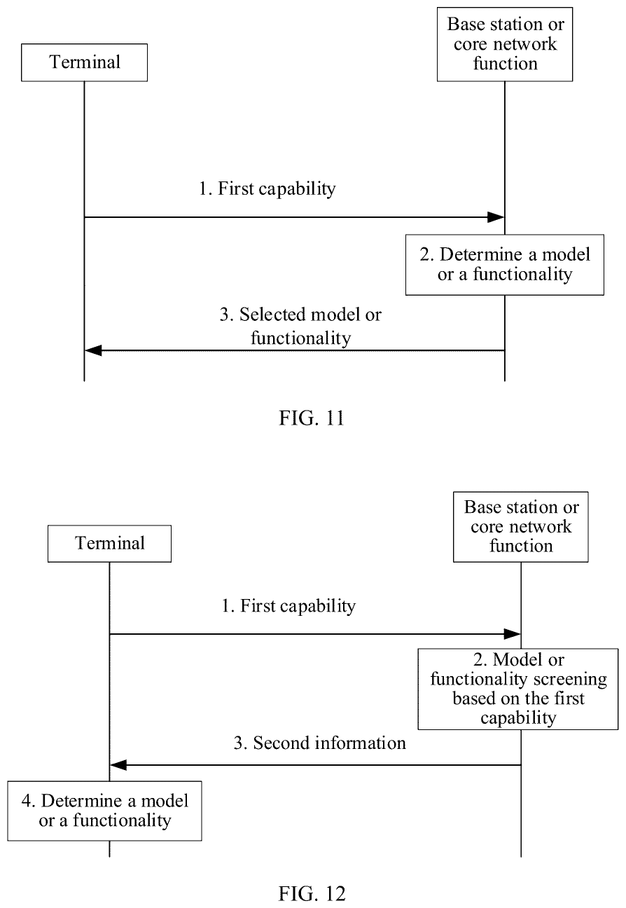

As shown in FIG. 11, the following step is included:

The first device sends first information to the second device. The first information includes a first capability. The first capability includes a connection capability, a computing power capability, an algorithm capability, and a data capability.

The connection capability refers to a terminal configuration.

The data capability includes a data item that can be provided and a supported data processing indicator, and the data processing indicator includes a specified neural network and/or a specified processing function.

The second device determines a model or a functionality based on the first capability, and feeds back a selection result to the first device.

When the first device is a terminal, and the second device is a base station or a core network function, the first capability may be carried by using capability report signaling.

Before the first device sends the first information to the second device, the second device may query the first capability of the first device.

Embodiment 9 (scenario 1c): Model selection is on a terminal, the first device is a terminal, and the second device is a base station or a core network function, where the first device is a model deployment device, and the second device is a model registration center or a model identification center.

As shown in FIG. 12, the following step is included:

The first device sends first information to the second device. The first information includes a first capability. The first capability includes a connection, a computing power capability, an algorithm capability, and a data capability.

The first device receives second information sent by the second device, and determines a model or a functionality. The second information includes developer information, model evaluation, and an inference condition. Model evaluation includes a historical evaluation result, a performance ranking, and cumulative online time. The inference condition includes a running range, a connection condition, a computing power condition, an algorithm condition, and a data condition.

The running range includes a quantity of involved terminals and base stations, for example, includes at least one of the following:
one base station and one terminal;
a plurality of base stations and one terminal;
one terminal and a plurality of base stations; and
a plurality of base stations and a plurality of terminals.

The connection capability may refer to a terminal configuration.

The data capability includes a data item that can be provided and a supported data processing indicator, and the data processing indicator includes a specified neural network and/or a specified processing function.

As shown in FIG. 12, the following step is further included:

The second device performs model screening based on the first capability to determine a candidate model or functionality.

When the first device is a terminal, and the second device is a base station or a core network function, the first capability may be carried by using capability report signaling.

Before the first device sends the first information to the second device, the second device may query the first capability of the first device.

The model information transmission method provided in the embodiments of this application may be performed by a model information transmission apparatus. In the embodiments of this application, the model information transmission apparatus provided in the embodiments of this application is described by using an example in which the model information transmission apparatus performs the model information transmission method.

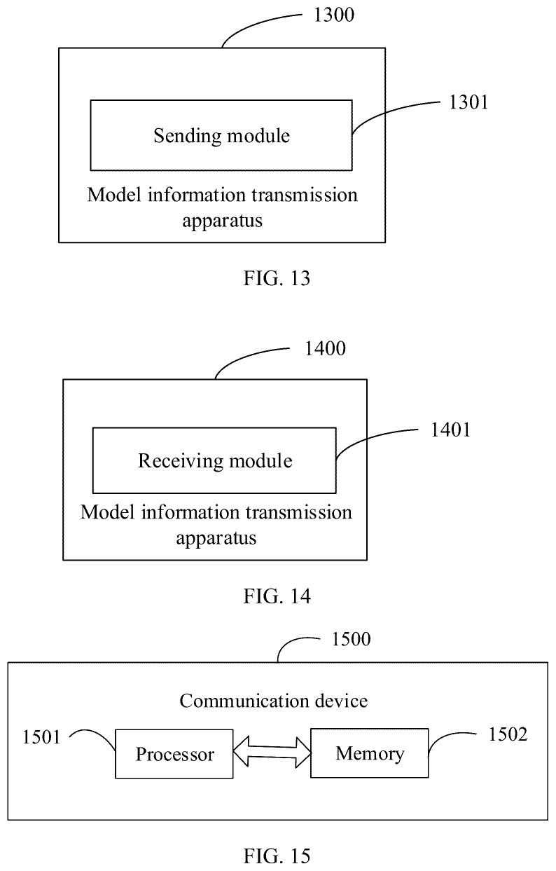

Referring to FIG. 13, FIG. 13 is a structural diagram of a model information transmission apparatus according to an embodiment of this application. As shown in FIG. 13, the model information transmission apparatus 1300 includes:

a sending module 1301, configured to send first information to a second device, where the first information includes at least one of the following:

artificial intelligence AI model description information, where the AI model description information is used to describe an AI model corresponding to the first device; and first capability information associated with an AI model, where the first capability information is used to select an AI model.

Optionally, the AI model description information includes at least one of the following:
an AI model functionality, an AI model usage condition, and AI model identifier information.

Optionally, the AI model description information is AI model description information of the AI model of the first device, and the AI model description information further includes at least one of the following:
identifier information of the AI model of the first device;
a predefined output format indication of the AI model of the first device;
a flexible output format indication of the AI model of the first device;
first cause information, where the first cause information is used to indicate that a trigger cause of the first information is that a network side uses an inference result of the AI model of a terminal; and
historical evaluation information or predictive evaluation information of the AI model of the first device.

Optionally, the historical evaluation information or the predictive evaluation information includes at least one of the following:
a performance metric and an assessment result.

Optionally, the AI model description information is AI model description information of the AI model of the first device, and the AI model functionality includes at least one of the following: a to-be-activated AI model functionality of the first device and a deployed AI model functionality of the first device.

The AI model description information further includes at least one of the following:
identifier information of a to-be-activated AI model of the first device; and
identifier information of a deployed AI model of the first device.

Optionally, the AI model description information further includes at least one of the
first identifier information of the AI model of the first device, where the first identifier information includes at least one of the following: the identifier information of the to-be-activated model of the first device;
historical evaluation information or predictive evaluation information of the AI model of the first device;
a lifecycle control authority over the AI model of the first device; and second cause information, where the second cause information is used to indicate that a trigger cause of the first information is activating the AI model of the first device.

Optionally, the lifecycle control authority includes at least one of the following:
a lifecycle control authority of the first device over the AI model of the first device; and
a lifecycle control authority of the second device over the AI model of the first device.

Optionally, the lifecycle control authority includes at least one of the following:
a model activation control right;
a model deactivation control right;
a model switching control right;
a model fallback control right; and
a model monitoring control right.

Optionally, the AI model usage condition includes at least one of the following:
an AI model configuration condition, an AI model scenario condition, and an AI model data condition.

Optionally, the AI model data condition includes at least one of the following:
network-side additional information, where the network-side additional information is used to indicate the second device to provide additional information for the AI model of the first device; and
a network-side additional configuration, where the network-side additional configuration is used to indicate the second device to perform related configuration for the AI model of the first device;
a network data processing indicator, where the network data processing indicator is used to indicate at least one of the following: a data processing manner for input data of the AI model of the first device and a data processing manner for output data of the AI model of the first device; and
split inference information, where the split inference information is information for performing model split inference by the first device and the second device.

Optionally, the performing model split inference by the first device and the second device includes:
serving, by the first device, as auxiliary inference of the AI model, and serving, by the second device, as joint inference of the AI model; or
serving, by the first device, as joint inference of the AI model, and serving, by the second device, as auxiliary inference of the AI model.

Optionally, the split inference information includes at least one of the following:
identifier information of the AI model of the first device;
identifier information of an AI model of the second device;
version information of the AI model of the first device;
version information of the AI model of the second device;
a length of the output data of the AI model of the first device; and
output usage information of the AI model of the first device.

Optionally, the output usage information of the AI model of the first device includes
at least one of the following:
position information in a case that the second device performs joint inference, where the position information specifies where the output data from the first device's AI model is mapped within joint inference model input grid; and
indication information, where the indication information is used to indicate joint calculation between the output of the AI model of the first device and an input of the AI model of the second device.

Optionally, the AI model description information AI model description information of the AI model of the first device, and the AI model functionality includes at least one of the following: a to-be-monitored AI model functionality of the first device and a non-to-be-monitored AI model functionality of the first device.

The AI model description information further includes at least one of the following:
identifier information of a to-be-monitored AI model of the first device; and
identifier information of a non-to-be-monitored AI model of the first device.

Optionally, the to-be-monitored AI model of the first device includes at least one of the following:
an activated AI model of the first device; and
an inactivated to-be-monitored AI model of the first device.

Optionally, the AI model description information further includes at least one of the
an associated performance metric of the AI model of the first device;
the historical evaluation information or the predictive evaluation information of the AI model of the first device;
status information of the AI model of the first device;

a first AI model data collection condition, where the first AI model data collection condition includes at least one of a monitoring data collection condition; and
third cause information, where the third cause information is used to indicate that the trigger cause of the first information is monitoring the AI model of the first device.

Optionally, the AI model description information further includes at least one of the following:
a second AI model data collection condition, where the second AI model data collection condition is a training data collection condition of the AI model of the first device; and
fourth cause information, where the fourth cause information is used to indicate that the trigger cause of the first information is that the network side assists the first device in collecting training data of the AI model of the first device.

Optionally, the AI model description information further includes at least one of the following:
a third AI model data collection condition, where the third AI model data collection condition is a training data collection condition of the AI model of the first device;
AI model training data configuration information; and
fifth cause information, where the fifth cause information is used to indicate that the trigger cause of the first information is that the network side collects training data of the AI model of the first device.

Optionally, the AI model training data configuration information includes at least one of the following:
an input data item of the AI model;
a label data item of the AI model;
an input data format of the AI model;
an output data format of the AI model;
a quantity of samples of the AI model;
a data storage requirement of the AI model; and
a third-party training configuration of the AI model.

Optionally, the apparatus further includes:
a first receiving module, configured to receive a first request sent by the second device, where the first request is used to request a to-be-collected data set.

Optionally, the apparatus further includes:
a second receiving module, configured to receive a second request sent by the second device, where the second request is used to request to obtain the first information.

Optionally, the apparatus further includes:
a third receiving module, configured to receive second information, where the second information includes information about at least one AI model.

The AI model description information includes:
description information of an AI model selected by the first device based on the second information.

Optionally, the information about the at least one AI model includes at least one of the following:
developer information of the at least one AI model;
evaluation information of the at least one AI model; and
an inference condition of the at least one AI model.

Optionally, the inference condition of the at least one AI model includes at least one of the following:
a running range of the at least one AI model, a connection condition of the at least one AI model, a computing power condition of the at least one AI model, an algorithm condition of the at least one AI model, and a data condition of the at least one AI model.

Optionally, the running range of the at least one AI model includes:
a quantity of devices involved in an inference result of the at least one AI model;
and/or the connection condition of the at least one AI model includes at least one of the following:
a terminal configuration of the at least one AI model and a network-side configuration of the at least one AI model;
and/or the data condition of the at least one AI model includes at least one of the following:
a data item of the at least one AI model and a data processing indicator of the at least one AI model.

Optionally, the data processing indicator includes at least one of the following:
a preprocessing indicator and a postprocessing indicator.

Optionally, the preprocessing indicator includes:
a preprocessing function indication, a one-hot encoding dictionary configuration, a data normalization parameter configuration, a data regularization parameter configuration, and a data standardization parameter configuration.

The postprocessing indicator includes at least one of the following:
a sparsification configuration indication;
a privatization configuration indication;
postprocessing on an output of an entire model; and
postprocessing on an output of a sub-model of the model.

Optionally, the first capability information includes:
a connection capability, a computing power capability, an algorithm capability, and a data capability.

Optionally, the connection capability includes a configuration for connecting to a network by the first device;
and/or the data capability includes at least one of the following:
a data item that can be provided and a supported data processing indicator.

Optionally, the apparatus further includes:
a fourth receiving module, configured to receive third information sent by the second device, where the third information includes information about an AI model or an AI model functionality selected by the second device based on the first information.

Optionally, the apparatus further includes:
a fifth receiving module, configured to receive fourth information sent by the second device, where the fourth information includes information about at least one AI model; and
a determining module, configured to determine at least one of an AI model and an AI model functionality based on the fourth information.

The foregoing model information transmission apparatus helps improve communication performance between the first device and the second device.

The model information transmission apparatus in the embodiments of this application may be an electronic device, for example, an electronic device with an operating system; or may be a component in an electronic device, for example, an integrated circuit or a chip. For example, the electronic device may be a terminal, or may be another device different from a terminal. For example, the terminal may include but is not limited to the foregoing listed types of the terminal in the embodiments of this application. The another device may be a server, a network attached storage (NAS), or the like. This is not specifically limited in the embodiments of this application.

The model information transmission apparatus provided in the embodiments of this application can implement processes implemented in the method embodiment shown in FIG. 2, and achieve a same technical effect. To avoid repetition, details are not described herein again.

Referring to FIG. 14, FIG. 14 is a structural diagram of a model information transmission apparatus according to an embodiment of this application. As shown in FIG. 14, the model information transmission apparatus 1400 includes:
a receiving module 1401, configured to receive first information sent by a first device, where the first information includes at least one of the following:
artificial intelligence AI model description information, where the AI model description information is used to describe an AI model corresponding to the first device; and
first capability information associated with an AI model, where the first capability information is used to select an AI model.

Optionally, the AI model description information includes at least one of the following:

an AI model functionality, an AI model usage condition, and AI model identifier information.

Optionally, the AI model description information is AI model description information of the AI model of the first device, and the AI model description information further includes at least one of the following:
identifier information of the AI model of the first device;
a predefined output format indication of the AI model of the first device;
a flexible output format indication of the AI model of the first device;
first cause information, where the first cause information is used to indicate that a trigger cause of the first information is that a network side uses an inference result of the AI model of a terminal; and
historical evaluation information or predictive evaluation information of the AI model of the first device.

Optionally, the historical evaluation information or the predictive evaluation information includes at least one of the following:
a performance metric and an assessment result.

Optionally, the AI model description information is AI model description information of the AI model of the first device, and the AI model functionality includes at least one of the following: a to-be-activated AI model functionality of the first device and a deployed AI model functionality of the first device.

The AI model description information further includes at least one of the following:
identifier information of a to-be-activated AI model of the first device; and
identifier information of a deployed AI model of the first device.

Optionally, the AI model description information further includes at least one of the following:
first identifier information of the AI model of the first device, where the first identifier information includes at least one of the following: the identifier information of the to-be-activated model of the first device;
historical evaluation information or predictive evaluation information of the AI model of the first device;
a lifecycle control authority over the AI model of the first device; and
second cause information, where the second cause information is used to indicate that a trigger cause of the first information is activating the AI model of the first device.

Optionally, the lifecycle control authority includes at least one of the following:
a lifecycle control authority of the first device over the AI model of the first device; and
a lifecycle control authority of the second device over the AI model of the first device.

Optionally, the lifecycle control authority includes at least one of the following:
a model activation control right;
a model deactivation control right;
a model switching control right;
a model fallback control right; and
a model monitoring control right.

Optionally, the AI model usage condition includes at least one of the following:
an AI model configuration condition, an AI model scenario condition, and an AI model data condition.

Optionally, the AI model data condition includes at least one of the following:
network-side additional information, where the network-side additional information is used to indicate the second device to provide additional information for the AI model of the first device; and
a network-side additional configuration, where the network-side additional configuration is used to indicate the second device to perform related configuration for the AI model of the first device;
a network data processing indicator, where the network data processing indicator is used to indicate at least one of the following: a data processing manner for input data of the AI model of the first device and a data processing manner for output data of the AI model of the first device; and
split inference information, where the split inference information is information for performing model split inference by the first device and the second device.

Optionally, the performing model split inference by the first device and the second device includes:
serving, by the first device, as auxiliary inference of the AI model, and serving, by the second device, as joint inference of the AI model; or
serving, by the first device, as joint inference of the AI model, and serving, by the second device, as auxiliary inference of the AI model.

Optionally, the split inference information includes at least one of the following:
identifier information of the AI model of the first device;
identifier information of an AI model of the second device;
version information of the AI model of the first device;
version information of the AI model of the second device;
a length of the output data of the AI model of the first device; and
output usage information of the AI model of the first device.

Optionally, the output usage information of the AI model of the first device includes at least one of the following:
position information in a case that the second device performs joint inference, where the position information specifies where the output data from the first device's AI model is mapped within joint inference model input grid; and
indication information, where the indication information is used to indicate joint calculation between the output of the AI model of the first device and an input of the AI model of the second device.

Optionally, the AI model description information AI model description information of the AI model of the first device, and the AI model functionality includes at least one of the following: a to-be-monitored AI model functionality of the first device and a non-to-be-monitored AI model functionality of the first device.

The AI model description information further includes:
identifier information of a to-be-monitored AI model of the terminal; and
identifier information of a non-to-be-monitored AI model of the terminal.

Optionally, the to-be-monitored AI model of the first device includes at least one of the following:
an activated AI model of the first device; and
an inactivated to-be-monitored AI model of the first device.

Optionally, the AI model description information further includes at least one of the following:
an associated performance metric of the AI model of the first device;
the historical evaluation information or the predictive evaluation information of the AI model of the first device;
status information of the AI model of the first device;
a first AI model data collection condition, where the first AI model data collection condition includes at least one of a monitoring data collection condition; and
third cause information, where the third cause information is used to indicate that the trigger cause of the first information is monitoring the AI model of the first device.

Optionally, the AI model description information further includes at least one of the following:
a second AI model data collection condition, where the second AI model data collection condition is a training data collection condition of the AI model of the first device; and
fourth cause information, where the fourth cause information is used to indicate that the trigger cause of the first information is that the network side assists the first device in collecting training data of the AI model of the first device.

Optionally, the AI model description information further includes at least one of the following:
a third AI model data collection condition, where the third AI model data collection condition is a training data collection condition of the AI model of the first device;
AI model training data configuration information; and
fifth cause information, where the fifth cause information is used to indicate that the trigger cause of the first information is that the network side collects training data of the AI model of the first device.

Optionally, the AI model training data configuration information includes at least one of the following:
an input data item of the AI model;
a label data item of the AI model;
an input data format of the AI model;
an output data format of the AI model;
a quantity of samples of the AI model;
a data storage requirement of the AI model; and
a third-party training configuration of the AI model.

Optionally, the apparatus further includes:
a first sending module, configured to send a first request to the first device, where the first request is used to request a to-be-collected data set.

Optionally, the apparatus further includes:
a second sending module, configured to send a second request to the first device, where the second request is used to request to obtain the first information.

Optionally, the apparatus further includes:
a third sending module, configured to send second information to the first device, where the second information includes information about at least one AI model.

The AI model description information includes:
description information of an AI model selected by the first device based on the second information.

Optionally, the information about the at least one AI model includes at least one of the following:
developer information of the at least one AI model;
evaluation information of the at least one AI model; and
an inference condition of the at least one AI model.

Optionally, the inference condition of the at least one AI model includes at least one of the following:
a running range of the at least one AI model, a connection condition of the at least one AI model, a computing power condition of the at least one AI model, an algorithm condition of the at least one AI model, and a data condition of the at least one AI model.

Optionally, the running range of the at least one AI model includes:
a quantity of devices involved in an inference result of the at least one AI model;
and/or the connection condition of the at least one AI model includes at least one of the following:
a terminal configuration of the at least one AI model and a network-side configuration of the at least one AI model;
and/or the data condition of the at least one AI model includes at least one of the following:
a data item of the at least one AI model and a data processing indicator of the at least one AI model.

Optionally, the data processing indicator includes at least one of the following:
a preprocessing indicator and a postprocessing indicator.

Optionally, the preprocessing indicator includes:
a preprocessing function indication, a one-hot encoding dictionary configuration, a data normalization parameter configuration, a data regularization parameter configuration, and a data standardization parameter configuration.

The postprocessing indicator includes at least one of the following:
a sparsification configuration indication;
a privatization configuration indication;
postprocessing on an output of an entire model; and
postprocessing on an output of a sub-model of the model.

Optionally, the apparatus further includes:
a determining module, configured to determine the at least one AI model based on at least one of an inference condition, information about the second device, and information about the first device.

Optionally, before the determining, by the second device, the at least one AI model based on at least one of an inference condition, information about the second device, and information about the first device, the receiving module is further configured to:
receive fifth information sent by a third device, where the fifth information includes AI model description information.

Optionally, the first capability information includes:
a connection capability, a computing power capability, an algorithm capability, and a data capability.

The connection capability includes a configuration for connecting to a network by the first device;
and/or the data capability includes at least one of the following:
a data item that can be provided and a supported data processing indicator.

Optionally, after the receiving, by a second device, first information sent by a first device, the method further includes:
sending, by the second device, third information to the first device, where the third information includes information about an AI model or an AI model functionality selected by the second device based on the first information.

Optionally, the apparatus further includes:
a fourth sending module, configured to send fourth information to the first device, where the fourth information includes information about at least one AI model.

The model information transmission apparatus in the embodiments of this application may be an electronic device, for example, an electronic device with an operating system; or may be a component in an electronic device, for example, an integrated circuit or a chip. The electronic device may be a terminal or a network-side device.

The model information transmission apparatus provided in the embodiments of this application can implement processes implemented in the method embodiment shown in FIG. 3, and achieve a same technical effect. To avoid repetition, details are not described herein again.

Optionally, as shown in FIG. 15, an embodiment of this application further provides a communication device 1500, including a processor 1501 and a memory 1502. The memory 1502 stores a program or instructions capable of running on the processor 1501. For example, when the communication device 1500 is a terminal, the program or the instructions are executed by the processor 1501 to implement the steps of the model information transmission method embodiment on the terminal side, and a same technical effect can be achieved. When the communication device 1500 is a network-side device, the program or the instructions are executed by the processor 1501 to implement the steps of the model information transmission method embodiment on the network side, and a same technical effect can be achieved. To avoid repetition, details are not described herein again.

An embodiment of this application further provides a communication device, including a processor and a communication interface. The communication interface is configured to send first information to a second device, where the first information includes at least one of the following: artificial intelligence AI model description information, where the AI model description information is used to describe an AI model corresponding to the first device; and first capability information associated with an AI model, where the first capability information is used to select an AI model. This communication device embodiment corresponds to the model information transmission method embodiment, and each implementation process and implementation of the method embodiment can be applied to this communication device embodiment, and a same technical effect can be achieved.

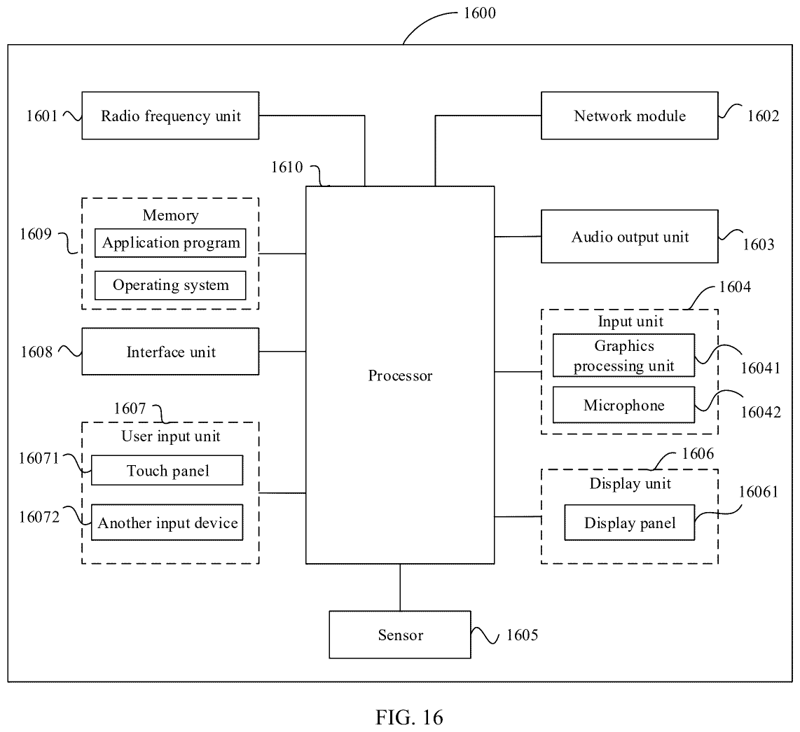

Specifically, FIG. 16 is a schematic diagram of a hardware structure of a communication device according to an embodiment of this application. The communication device is a first device. In this embodiment, an example in which the first device is a terminal is used for description.

The communication device 1600 includes but is not limited to at least a part of components in a radio frequency unit 1601, a network module 1602, an audio output unit 1603, an input unit 1604, a sensor 1605, a display unit 1606, a user input unit 1607, an interface unit 1608, a memory 1609, a processor 1610, and the like.

A person skilled in the art may understand that the communication device 1600 may further include a power supply (for example, a battery) that supplies power to each component. The power supply may be logically connected to the processor 1610 by using a power management system, to implement functions such as charging management, discharging management, and power consumption management by using the power management system. The structure of the communication device shown in FIG. 16 does not constitute a limitation on the communication device. The communication device may include more or fewer components than those shown in the figure, or combine some components, or have different component arrangements. Details are not described herein again.

It should be understood that in this embodiment of this application, the input unit 1604 may include a graphics processing unit (GPU) 16041 and a microphone 16042, and the graphics processing unit 16041 processes image data of a still picture or a video obtained by an image capture apparatus (for example, a camera) in a video capture mode or an image capture mode. The display unit 1606 may include a display panel 16061, and the display panel 16061 may be configured in a form of a liquid crystal display, an organic light-emitting diode, or the like. The user input unit 1607 includes at least one of a touch panel 16071 or another input device 16072. The touch panel 16071 is also referred to as a touchscreen. The touch panel 16071 may include two parts: a touch detection apparatus and a touch controller. The another input device 16072 may include but is not limited to a physical keyboard, a function key (such as a volume control key or an on/off key), a trackball, a mouse, and an operating lever. Details are not described herein again.

In this embodiment of this application, after receiving downlink data from a network-side device, the radio frequency unit 1601 may transmit the downlink data to the processor 1610 for processing. In addition, the radio frequency unit 1601 may send uplink data to a network-side device. Generally, the radio frequency unit 1601 includes but is not limited to an antenna, an amplifier, a transceiver, a coupler, a low-noise amplifier, a duplexer, and the like.

The memory 1609 may be configured to store a software program or instructions and various types of data. The memory 1609 may mainly include a first storage area for storing a program or instructions and a second storage area for storing data. The first storage area may store an operating system, an application program or instructions required by at least one function (for example, a sound play function or an image play function), and the like. In addition, the memory 1609 may include a volatile memory or a non-volatile memory, or the memory 1609 may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synch link dynamic random access memory (SLDRAM), and a direct rambus random access memory (DRRAM). The memory 1609 in this embodiment of this application includes but is not limited to these memories and any other suitable type of memory.

The processor 1610 may include one or more processing units. Optionally, the processor 1610 integrates an application processor and a modem processor. The application processor mainly processes operations related to an operating system, a user interface, an application program, and the like. The modem processor, for example, a baseband processor, mainly processes a wireless communication signal. It may be understood that, the foregoing modem processor may not be integrated into the processor 1610.

The radio frequency unit 1601 is configured to send first information to a second device, where the first information includes at least one of the following:

AI model description information, where the AI model description information is used to describe an AI model corresponding to the first device; and first capability information associated with an AI model, where the first capability information is used to select an AI model.

Optionally, the AI model description information includes at least one of the
an AI model functionality, an AI model usage condition, and AI model identifier information.

Optionally, the AI model description information is AI model description information of the AI model of the first device, and the AI model description information further includes at least one of the following:
identifier information of the AI model of the first device;
a predefined output format indication of the AI model of the first device;
a flexible output format indication of the AI model of the first device;
first cause information, where the first cause information is used to indicate that a trigger cause of the first information is that a network side uses an inference result of the AI model of a terminal; and
historical evaluation information or predictive evaluation information of the AI model of the first device.

Optionally, the historical evaluation information or the predictive evaluation information includes at least one of the following:
a performance metric and an assessment result.

Optionally, the AI model description information is AI model description information of the AI model of the first device, and the AI model functionality includes at least one of the following: a to-be-activated AI model functionality of the first device and a deployed AI model functionality of the first device.

The AI model description information further includes at least one of the following:
identifier information of a to-be-activated AI model of the first device; and
identifier information of a deployed AI model of the first device.

Optionally, the AI model description information further includes at least one of the following:
first identifier information of the AI model of the first device, where the first identifier information includes at least one of the following: the identifier information of the to-be-activated model of the first device;
historical evaluation information or predictive evaluation information of the AI model of the first device;
a lifecycle control authority over the AI model of the first device; and
second cause information, where the second cause information is used to indicate that a trigger cause of the first information is activating the AI model of the first device.

Optionally, the lifecycle control authority includes at least one of the following:
a lifecycle control authority of the first device over the AI model of the first device; and
a lifecycle control authority of the second device over the AI model of the first device.

Optionally, the lifecycle control authority includes at least one of the following:
a model activation control right;
a model deactivation control right;
a model switching control right;
a model fallback control right; and
a model monitoring control right.

Optionally, the AI model usage condition includes at least one of the following:
an AI model configuration condition, an AI model scenario condition, and an AI model data condition.

Optionally, the AI model data condition includes at least one of the following:
network-side additional information, where the network-side additional information is used to indicate the second device to provide additional information for the AI model of the first device; and
a network-side additional configuration, where the network-side additional configuration is used to indicate the second device to perform related configuration for the AI model of the first device;
a network data processing indicator, where the network data processing indicator is used to indicate at least one of the following: a data processing manner for input data of the AI model of the first device and a data processing manner for output data of the AI model of the first device; and s
plit inference information, where the split inference information is information for performing model split inference by the first device and the second device.

Optionally, the performing model split inference by the first device and the second device includes:
serving, by the first device, as auxiliary inference of the AI model, and serving, by the second device, as joint inference of the AI model; or
serving, by the first device, as joint inference of the AI model, and serving, by the second device, as auxiliary inference of the AI model.

Optionally, the split inference information includes at least one of the following:
identifier information of the AI model of the first device;
identifier information of an AI model of the second device;
version information of the AI model of the first device;
version information of the AI model of the second device;
a length of the output data of the AI model of the first device; and output usage information of the AI model of the first device.

Optionally, the output usage information of the AI model of the first device includes at least one of the following:
position information in a case that the second device performs joint inference, where the position information specifies where the output data from the first device's AI model is mapped within joint inference model input grid; and
indication information, where the indication information is used to indicate joint calculation between the output of the AI model of the first device and an input of the AI model of the second device.

Optionally, the AI model description information AI model description information of the AI model of the first device, and the AI model functionality includes at least one of the following: a to-be-monitored AI model functionality of the first device and a non-to-be-monitored AI model functionality of the first device.

The AI model description information further includes at least one of the following:
identifier information of a to-be-monitored AI model of the first device; and
identifier information of a non-to-be-monitored AI model of the first device.

Optionally, the to-be-monitored AI model of the first device includes at least one of the following:
an activated AI model of the first device; and
an inactivated to-be-monitored AI model of the first device.

Optionally, the AI model description information further includes at least one of the following:
an associated performance metric of the AI model of the first device;
the historical evaluation information or the predictive evaluation information of the AI model of the first device;
status information of the AI model of the first device;
a first AI model data collection condition, where the first AI model data collection condition includes at least one of a monitoring data collection condition; and
third cause information, where the third cause information is used to indicate that the trigger cause of the first information is monitoring the AI model of the first device.

Optionally, the AI model description information further includes at least one of the following:
a second AI model data collection condition, where the second AI model data collection condition is a training data collection condition of the AI model of the first device; and
fourth cause information, where the fourth cause information is used to indicate that the trigger cause of the first information is that the network side assists the first device in collecting training data of the AI model of the first device.

Optionally, the AI model description information further includes at least one of the following:
a third AI model data collection condition, where the third AI model data collection condition is a training data collection condition of the AI model of the first device;
AI model training data configuration information; and
fifth cause information, where the fifth cause information is used to indicate that the trigger cause of the first information is that the network side collects training data of the AI model of the first device.

Optionally, the AI model training data configuration information includes at least one of the following:
an input data item of the AI model;
a label data item of the AI model;
an input data format of the AI model;
an output data format of the AI model;
a quantity of samples of the AI model;
a data storage requirement of the AI model; and
a third-party training configuration of the AI model.

Optionally, before sending the first information to the second device, the radio frequency unit 1601 is further configured to:
receive a first request sent by the second device, where the first request is used to request a to-be-collected data set.

Optionally, before sending the first information to the second device, the radio frequency unit 1601 is further configured to:
receive a second request sent by the second device, where the second request is used to request to obtain the first information.

Optionally, before sending the first information to the second device, the radio frequency unit 1601 is further configured to:
receive second information, where the second information includes information about at least one AI model.

The AI model description information includes:
description information of an AI model selected by the first device based on the second information.

Optionally, the information about the at least one AI model includes at least one of the following:
developer information of the at least one AI model;
evaluation information of the at least one AI model; and
an inference condition of the at least one AI model.

Optionally, the inference condition of the at least one AI model includes at least one of the following:
a running range of the at least one AI model, a connection condition of the at least one AI model, a computing power condition of the at least one AI model, an algorithm condition of the at least one AI model, and a data condition of the at least one AI model.

Optionally, the running range of the at least one AI model includes:
a quantity of devices involved in an inference result of the at least one AI model; and/or the connection condition of the at least one AI model includes at least one of the following:
a terminal configuration of the at least one AI model and a network-side configuration of the at least one AI model;
and/or the data condition of the at least one AI model includes at least one of the following:
a data item of the at least one AI model and a data processing indicator of the at least one AI model.

Optionally, the data processing indicator includes at least one of the following:
a preprocessing indicator and a postprocessing indicator.

Optionally, the preprocessing indicator includes:
a preprocessing function indication, a one-hot encoding dictionary configuration, a data normalization parameter configuration, a data regularization parameter configuration, and a data standardization parameter configuration.

The postprocessing indicator includes at least one of the following:
a sparsification configuration indication;
a privatization configuration indication;
postprocessing on an output of an entire model; and
postprocessing on an output of a sub-model of the model.

Optionally, the first capability information includes:
a connection capability, a computing power capability, an algorithm capability, and a data capability.

Optionally, the connection capability includes a configuration for connecting to a network by the first device;
and/or the data capability includes at least one of the following:
a data item that can be provided and a supported data processing indicator.

Optionally, after sending the first information to the second device, the radio frequency unit 1601 is further configured to:
receive third information sent by the second device, where the third information includes information about an AI model or an AI model functionality selected by the second device based on the first information.

Optionally, before sending the first information to the second device, the radio frequency unit 1601 is further configured to:
receive fourth information sent by the second device, where the fourth information includes information about at least one AI model.

The processor 1610 is configured to determine at least one of an AI model and an AI model functionality based on the fourth information.

The foregoing communication device helps improve communication performance between the first device and the second device.

An embodiment of this application further provides a communication device, including a processor and a communication interface. The communication interface is configured to receive first information sent by a first device, where the first information includes at least one of the following: artificial intelligence AI model description information, where the AI model description information is used to describe an AI model corresponding to the first device; and first capability information associated with an AI model, where the first capability information is used to select an AI model. This communication device embodiment corresponds to the model information transmission method embodiment, and each implementation process and implementation of the method embodiment can be applied to this communication device embodiment, and a same technical effect can be achieved.

Specifically, an embodiment of this application further provides a communication device, and the communication device is a second device. In this embodiment, an example in which the second device is an access network device is used for description.

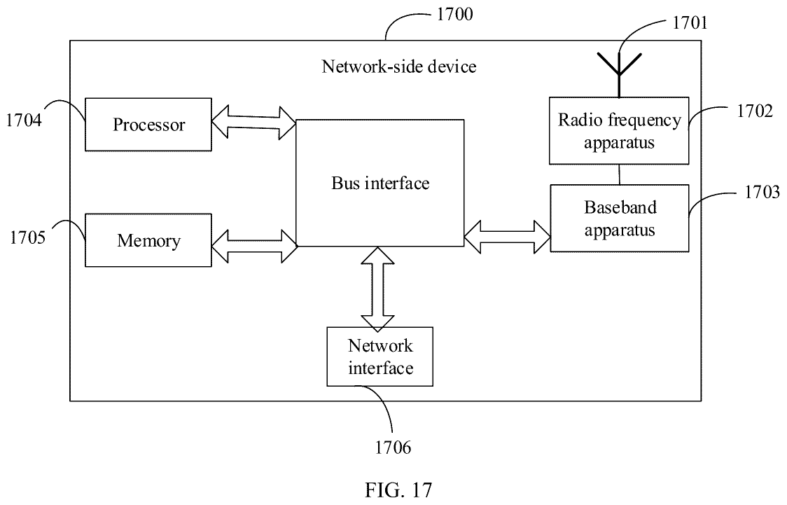

As shown in FIG. 17, the communication device 1700 includes an antenna 1701, a radio frequency apparatus 1702, a baseband apparatus 1703, a processor 1704, and a memory 1705. The antenna 1701 is connected to the radio frequency apparatus 1702. In an uplink direction, the radio frequency apparatus 1702 receives information through the antenna 1701, and sends the received information to the baseband apparatus 1703 for processing. In a downlink direction, the baseband apparatus 1703 processes to-be-sent information, and sends processed information to the radio frequency apparatus 1702. After processing the received information, the radio frequency apparatus 1702 sends processed information through the antenna 1701.

The method performed by the communication device in the foregoing embodiment may be implemented in the baseband apparatus 1703. The baseband apparatus 1703 includes a baseband processor.

For example, the baseband apparatus 1703 may include at least one baseband board. A plurality of chips are disposed on the baseband board. As shown in FIG. 17, one of the chips is, for example, the baseband processor, and is connected to the memory 1705 by using a bus interface, to invoke a program in the memory 1705 to perform an operation of a network device shown in the foregoing method embodiment.

The communication device may further include a network interface 1706. For example, the interface is a common public radio interface (CPRI).

Specifically, the communication device 1700 in this embodiment of this application further includes instructions or a program that is stored in the memory 1705 and that is capable of running on the processor 1704. The processor 1704 invokes the instructions or the program in the memory 1705 to perform the method performed by the modules shown in FIG. 14, and a same technical effect is achieved. To avoid repetition, details are not described herein again.

The radio frequency apparatus 1702 is configured to receive first information sent by a first device, where the first information includes at least one of the following:
AI model description information, where the AI model description information is used to describe an AI model corresponding to the first device; and
first capability information associated with an AI model, where the first capability information is used to select an AI model.

Optionally, the AI model description information includes at least one of the
an AI model functionality, an AI model usage condition, and AI model identifier information.

Optionally, the AI model description information is AI model description information of the AI model of the first device, and the AI model description information further includes at least one of the following:
identifier information of the AI model of the first device;
a predefined output format indication of the AI model of the first device;
a flexible output format indication of the AI model of the first device;
first cause information, where the first cause information is used to indicate that a trigger cause of the first information is that a network side uses an inference result of the AI model of a terminal; and
historical evaluation information or predictive evaluation information of the AI model of the first device.

Optionally, the historical evaluation information or the predictive evaluation information includes at least one of the following:
a performance metric and an assessment result.

Optionally, the AI model description information is AI model description information of the AI model of the first device, and the AI model functionality includes at least one of the following: a to-be-activated AI model functionality of the first device and a deployed AI model functionality of the first device.

The AI model description information further includes at least one of the following:
identifier information of a to-be-activated AI model of the first device; and
identifier information of a deployed AI model of the first device.

Optionally, the AI model description information further includes at least one of the following:
first identifier information of the AI model of the first device, where the first identifier information includes at least one of the following: the identifier information of the to-be-activated model of the first device;
historical evaluation information or predictive evaluation information of the AI model of the first device;
a lifecycle control authority over the AI model of the first device; and
second cause information, where the second cause information is used to indicate that a trigger cause of the first information is activating the AI model of the first device.

Optionally, the lifecycle control authority includes at least one of the following:
a lifecycle control authority of the first device over the AI model of the first device; and
a lifecycle control authority of the second device over the AI model of the first device.

Optionally, the lifecycle control authority includes at least one of the following:
a model activation control right;
a model deactivation control right;
a model switching control right;
a model fallback control right; and
a model monitoring control right.

Optionally, the AI model usage condition includes at least one of the following:
an AI model configuration condition, an AI model scenario condition, and an AI model data condition.

Optionally, the AI model data condition includes at least one of the following:
network-side additional information, where the network-side additional information is used to indicate the second device to provide additional information for the AI model of the first device; and
a network-side additional configuration, where the network-side additional configuration is used to indicate the second device to perform related configuration for the AI model of the first device;
a network data processing indicator, where the network data processing indicator is used to indicate at least one of the following: a data processing manner for input data of the AI model of the first device and a data processing manner for output data of the AI model of the first device; and
split inference information, where the split inference information is information for performing model split inference by the first device and the second device.

Optionally, the performing model split inference by the first device and the second device includes:
serving, by the first device, as auxiliary inference of the AI model, and serving, by the second device, as joint inference of the AI model; or
serving, by the first device, as joint inference of the AI model, and serving, by the second device, as auxiliary inference of the AI model.

Optionally, the split inference information includes at least one of the following:
identifier information of the AI model of the first device;
identifier information of an AI model of the second device;
version information of the AI model of the first device;
version information of the AI model of the second device;
a length of the output data of the AI model of the first device; and
output usage information of the AI model of the first device.

Optionally, the output usage information of the AI model of the first device includes at least one of the following:
position information in a case that the second device performs joint inference, where the position information specifies where the output data from the first device's AI model is mapped within joint inference model input grid; and
indication information, where the indication information is used to indicate joint calculation between the output of the AI model of the first device and an input of the AI model of the second device.

Optionally, the AI model description information AI model description information of the AI model of the first device, and the AI model functionality includes at least one of the following: a to-be-monitored AI model functionality of the first device and a non-to-be-monitored AI model functionality of the first device.

The AI model description information further includes:
identifier information of a to-be-monitored AI model of the terminal; and
identifier information of a non-to-be-monitored AI model of the terminal.

Optionally, the to-be-monitored AI model of the first device includes at least one of the following:
an activated AI model of the first device; and
an inactivated to-be-monitored AI model of the first device.

Optionally, the AI model description information further includes at least one of the following:
an associated performance metric of the AI model of the first device;
the historical evaluation information or the predictive evaluation information of the AI model of the first device;
status information of the AI model of the first device;
a first AI model data collection condition, where the first AI model data collection condition includes at least one of a monitoring data collection condition; and
third cause information, where the third cause information is used to indicate that the trigger cause of the first information is monitoring the AI model of the first device.

Optionally, the AI model description information further includes at least one of the
a second AI model data collection condition, where the second AI model data collection condition is a training data collection condition of the AI model of the first device; and
fourth cause information, where the fourth cause information is used to indicate that the trigger cause of the first information is that the network side assists the first device in collecting training data of the AI model of the first device.

Optionally, the AI model description information further includes at least one of the following:
a third AI model data collection condition, where the third AI model data collection condition is a training data collection condition of the AI model of the first device;
AI model training data configuration information; and
fifth cause information, where the fifth cause information is used to indicate that the trigger cause of the first information is that the network side collects training data of the AI model of the first device.

Optionally, the AI model training data configuration information includes at least one of the following:
an input data item of the AI model;
a label data item of the AI model;
an input data format of the AI model;
an output data format of the AI model;
a quantity of samples of the AI model;
a data storage requirement of the AI model; and
a third-party training configuration of the AI model.

Optionally, before receiving the first information sent by the first device, the radio frequency apparatus 1702 is further configured to:
send a first request to the first device, where the first request is used to request a to-be-collected data set.

Optionally, before receiving the first information sent by the first device, the radio frequency apparatus 1702 is further configured to:
send a second request to the first device, where the second request is used to request to obtain the first information.

Optionally, before receiving the first information sent by the first device, the radio frequency apparatus 1702 is further configured to:
send second information to the first device, where the second information includes information about at least one AI model.

The AI model description information includes:
description information of an AI model selected by the first device based on the second information.

Optionally, the information about the at least one AI model includes at least one of the following:
developer information of the at least one AI model;
evaluation information of the at least one AI model; and
an inference condition of the at least one AI model.

Optionally, the inference condition of the at least one AI model includes at least one of the following:
a running range of the at least one AI model, a connection condition of the at least one AI model, a computing power condition of the at least one AI model, an algorithm condition of the at least one AI model, and a data condition of the at least one AI model.

Optionally, the running range of the at least one AI model includes:
a quantity of devices involved in an inference result of the at least one AI model;
and/or the connection condition of the at least one AI model includes at least one of the following:
a terminal configuration of the at least one AI model and a network-side configuration of the at least one AI model;
and/or the data condition of the at least one AI model includes at least one of the following:
a data item of the at least one AI model and a data processing indicator of the at least one AI model.

Optionally, the data processing indicator includes at least one of the following:
a preprocessing indicator and a postprocessing indicator.

Optionally, the preprocessing indicator includes:
a preprocessing function indication, a one-hot encoding dictionary configuration, a data normalization parameter configuration, a data regularization parameter configuration, and a data standardization parameter configuration.

The postprocessing indicator includes at least one of the following:
a sparsification configuration indication;
a privatization configuration indication;
postprocessing on an output of an entire model; and
postprocessing on an output of a sub-model of the model.

Optionally, before the second information is sent to the first device, the processor 1704 is configured to:
determine the at least one AI model based on at least one of an inference condition, information about the second device, and information about the first device.

Optionally, before the second device determines the at least one AI model based on at least one of the inference condition, the information about the second device, and the information about the first device, the radio frequency apparatus 1702 is further configured to:
receive fifth information sent by a third device, where the fifth information includes AI model description information.

Optionally, the first capability information includes:
a connection capability, a computing power capability, an algorithm capability, and a data capability.

The connection capability includes a configuration for connecting to a network by the first device;
and/or the data capability includes at least one of the following:
a data item that can be provided and a supported data processing indicator.

Optionally, after receiving the first information sent by the first device, the radio frequency apparatus 1702 is further configured to:
send third information to the first device, where the third information includes information about an AI model or an AI model functionality selected by the second device based on the first information.

Optionally, before receiving the first information sent by the first device, the radio frequency apparatus 1702 is further configured to:
send fourth information to the first device, where the fourth information includes information about at least one AI model.

The foregoing communication device helps improve communication performance between the first device and the second device.

An embodiment of this application further provides a readable storage medium, where the readable storage medium stores a program or instructions, and the program or the instructions are executed by a processor to implement the steps of the model information transmission method provided in the embodiments of this application.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface. The communication interface is coupled to the processor. The processor is configured to run a program or instructions to implement the processes in the model information transmission method embodiment, and a same technical effect can be achieved. To avoid repetition, details are not described herein again.

It should be understood that, the chip mentioned in this embodiment of this application may also be referred to as a system-level chip, a system chip, a chip system, or a system on chip.

An embodiment of this application further provides a computer program/program product. The computer program/program product is stored in a storage medium. The computer program/program product is executed by at least one processor to implement the processes in the model information transmission method embodiment, and a same technical effect can be achieved. To avoid repetition, details are not described herein again.

An embodiment of this application further provides a model information transmission system, including a first device and a second device, where the first device may be configured to perform the steps of the model information transmission method on the first device side provided in the embodiments of this application, and the second device may be configured to perform the steps of the model information transmission method on the second device side provided in the embodiments of this application.

It should be noted that in this specification, the term “comprise”, “include”, or any of their variants are intended to cover a non-exclusive inclusion, so that a process, a method, an article, or an apparatus that includes a list of elements not only includes those elements but also includes other elements that are not expressly listed, or further includes elements inherent to such process, method, article, or apparatus. Without more constraints, an element preceded by “includes a . . . ” does not preclude the existence of additional identical elements in the process, method, article, or apparatus that includes the element. In addition, it should be noted that, the scope of the method and apparatus in the implementations of this application is not limited to performing functions in a sequence shown or discussed, and may further include performing functions in a basically simultaneous manner or in a reverse order based on the functions involved. For example, the described method may be performed in an order different from the order described, and various steps may be added, omitted, or combined. In addition, features described with reference to some examples may be combined in other examples.

According to the foregoing descriptions of the implementations, a person skilled in the art may clearly understand that the method in the foregoing embodiments may be implemented by software and a necessary general-purpose hardware platform, or certainly may be implemented by hardware. However, in many cases, the former is a better implementation. Based on such an understanding, the technical solutions of this application essentially or the part contributing to the prior art may be implemented in a form of a computer software product. The computer software product is stored in a storage medium (for example, a ROM/RAM, a magnetic disk, or an optical disc), and includes several instructions for instructing a terminal (which may be a mobile phone, a computer, a server, an air conditioner, a network device, or the like) to perform the methods described in the embodiments of this application.

The foregoing describes the embodiments of this application with reference to the accompanying drawings. However, this application is not limited to the foregoing specific embodiments. The foregoing specific embodiments are merely illustrative rather than restrictive. Inspired by this application, a person of ordinary skill in the art may develop many other manners without departing from principles of this application and the protection scope of the claims, and all such manners fall within the protection scope of this application.

1. A model information transmission method, comprising:
sending, by a first device, first information to a second device, wherein the first information comprises at least one of the following:
artificial intelligence (AI) model description information, wherein the AI model description information is used to describe an AI model corresponding to the first device; or
first capability information associated with an AI model, wherein the first capability information is used to select an AI model.

2. The method according to claim 1, wherein the AI model description information comprises at least one of the following:
an AI model functionality, an AI model usage condition, or AI model identifier information.

3. The method according to claim 2, wherein the AI model description information is AI model description information of the AI model of the first device, and the AI model functionality comprises at least one of the following: a to-be-activated AI model functionality of the first device or a deployed AI model functionality of the first device; and
the AI model description information further comprises at least one of the following:
identifier information of a to-be-activated AI model of the first device; or
identifier information of a deployed AI model of the first device.

4. The method according to claim 2, wherein the AI model usage condition comprises at least one of the following:
an AI model configuration condition, an AI model scenario condition, or an AI model data condition.

5. The method according to claim 4, wherein in the AI model configuration condition, a configuration of the second device is implicitly indicated by a configuration identifier.

6. The method according to claim 4, wherein an explicit configuration of the second device comprises at least one of the following:
antenna configuration information of the second device;
beam configuration information of the second device;
height information of the second device; or
inter-site distance information of the second device.

7. The method according to claim 4, wherein the AI model data condition is an AI model data collection condition, or is configured to indicate an inference data configuration condition of the AI model.

8. The method according to claim 4, wherein the AI model data condition comprises at least one of the following:
network-side additional information, wherein the network-side additional information is used to indicate the second device to provide additional information for the AI model of the first device; and
a network-side additional configuration, wherein the network-side additional configuration comprises measurement resources, wherein the network-side additional configuration is used to indicate the second device to perform related configuration for the AI model of the first device;
a network data processing indicator, wherein the network data processing indicator is used to indicate at least one of the following: a data processing manner for input data of the AI model of the first device or a data processing manner for output data of the AI model of the first device; or
split inference information, wherein the split inference information is information for performing model split inference by the first device and the second device.

9. The method according to claim 8, wherein the performing model split inference by the first device and the second device comprises:
performing, by the first device, a first part of inference and then performing, by the second device, a remaining part of the inference; or
performing, by the second device, a first part of inference and then performing, by the first device, a remaining part of the inference.

10. The method according to claim 2, wherein before the sending, by a first device, first information to a second device, the method further comprises:
receiving, by the first device, a second request sent by the second device, wherein the second request is used to request to obtain the first information.

11. The method according to claim 2, wherein before the sending, by a first device, first information to a second device, the method further comprises:
receiving, by the first device, second information, wherein the second information comprises information about at least one AI model; and
the AI model description information comprises:
description information of an AI model selected by the first device based on the second information.

12. The method according to claim 11, wherein the information about the at least one AI model comprises at least one of the following:
developer information of the at least one AI model;
evaluation information of the at least one AI model; or
an inference condition of the at least one AI model.

13. The method according to claim 12, wherein the inference condition of the at least one AI model comprises at least one of the following:
a running range of the at least one AI model, a connection condition of the at least one AI model, a computing power condition of the at least one AI model, an algorithm condition of the at least one AI model, or a data condition of the at least one AI model.

14. The method according to claim 13, wherein the running range of the at least one AI model comprises:
a quantity of devices involved in an inference result of the at least one AI model;
and/or the connection condition of the at least one AI model comprises at least one of the following:
a terminal configuration of the at least one AI model or a network-side configuration of the at least one AI model, wherein the network-side configuration is explicitly indicated, or is implicitly indicated by a configuration identifier;
and/or the data condition of the at least one AI model comprises at least one of the following:
a data item of the at least one AI model or a data processing indicator of the at least one AI model.

15. The method according to claim 2, wherein the first capability information comprises:
a connection capability, a computing power capability, an algorithm capability, and a data capability.

16. The method according to claim 15, wherein the connection capability comprises a configuration for connecting to a network by the first device;
and/or the data capability comprises at least one of the following:
a data item that can be provided or a supported data processing indicator.

17. The method according to claim 15, wherein after the sending, by a first device, first information to a second device, the method further comprises:
receiving, by the first device, third information sent by the second device, wherein the third information comprises information about an AI model or an AI model functionality selected by the second device based on the first information.

18. A model information transmission method, comprising:
receiving, by a second device, first information sent by a first device, wherein the first information comprises at least one of the following:
artificial intelligence (AI) model description information, wherein the AI model description information is used to describe an AI model corresponding to the first device; or
first capability information associated with an AI model, wherein the first capability information is used to select an AI model.

19. A communication device, wherein the communication device is a first device, and comprises a processor and a memory, the memory stores a program or instructions capable of running on the processor, wherein the program or the instructions, when executed by the processor, cause the processor to perform:
sending first information to a second device, wherein the first information comprises at least one of the following:
artificial intelligence AI model description information, wherein the AI model description information is used to describe an AI model corresponding to the first device; or
first capability information associated with an AI model, wherein the first capability information is used to select an AI model.

20. A communication device, wherein the communication device is a second device, and comprises a processor and a memory, the memory stores a program or instructions capable of running on the processor, and the program or the instructions are executed by the processor to implement the steps of the model information transmission method according to claim 18.
